(19) United States
(12) Patent Application Publication
(10) Pub. No.: US 2026/0342760 A1
(43) Pub. Date: Oct. 29, 2026

(54) ARCHIVAL MESSAGE DEPOSIT CONFIRMATION FOR MESSAGING SYSTEMS AND APPLICATIONS

(71) Applicant: T-MOBILE INNOVATIONS LLC, Overland Park, KS (US)

(72) Inventor: Mark Daniel ALLEN, Renton, WA (US)

(21) Appl. No.: 19/188,996

(22) Filed: Apr. 24, 2025

(51) Int. Cl. H04L 51/216

(52) U.S. Cl. CPC H04L 51/216

(57) ABSTRACT

In various examples, archival message deposit confirmation for messaging systems and applications is provided. Archival message deposit confirmation logic may be integrated into a messaging system to hold delivery of a message pending receipt of a positive deposit acknowledgement, where the message may be released for delivery upon receiving the positive acknowledgement. Archival message deposit confirmation may be based on a routing server acknowledgement—where a message archival routing server confirms it is assuming responsibility for completing the task of depositing the message archive to the appropriate archive system endpoint. Alternatively, archival message deposit confirmation for a subscriber may be based on an archival endpoint acknowledgement—where an archive system endpoint confirms that it has received the copy of the transmitted message for deposit. In some embodiments, if no positive acknowledgement is received within a timeout period (or a negative acknowledgement is received), then message delivery may be blocked.

### BACKGROUND

In recent years, regulatory entities in many countries have imposed stringent compliance requirements on companies to ensure the preservation of electronic communications carried through messaging services. These regulations mandate that companies must maintain and archive electronic communications, including emails, text messages, social media interactions, and communications via collaboration platforms. The primary objective is to ensure that these records are readily accessible for regulatory review and audits, thereby safeguarding against potential misconduct and ensuring transparency in business operations. Companies are required to implement robust recordkeeping systems that can capture, store, and retrieve electronic communications in a secure and tamper-proof manner.

To comply with these regulations, companies must prepare and implement comprehensive policies and procedures that govern the use of electronic messaging services. This includes establishing protocols for monitoring and archiving communications conducted for business purposes, and ensuring that recordkeeping systems are in place that are capable of preserving the integrity and confidentiality of the stored communications, preventing unauthorized access or alterations. Regular audits and assessments of these systems may be conducted to identify and rectify any compliance gaps. Failure to adhere to these requirements can result in substantial fines and/or other penalties.

Message archival services are services that may be provided by an internet protocol (IP)-based messaging service (e.g., an instant message service) to help organizations meet regulatory compliance and legal requirements and/or assist in troubleshooting tasks. Such message archival services aim to ensure that all communications carried by the messaging service (e.g., text messages (Short Message Service (SMS), Multimedia Messaging Service (MMS)), rich communication services (RCS), etc.) are securely stored and can be retrieved when needed. The ability to access message archives is particularly important for industries where regulations mandate the retention and accessibility of communication records.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In contrast to prior solutions, one or more of the embodiments presented herein provide for archival message deposit confirmation logic that may be integrated into an IMS core of a messaging system, to control the messaging system to hold delivery of a message while waiting for receipt of a positive deposit acknowledgement. The message may then be released for delivery upon the IMS core receiving a positive acknowledgement. Archival message deposit confirmation may be selectively based on different types of acknowledgements depending on the degree of assurance that a message archiving system subscriber desires that user messages are being archived as intended. For example, in some embodiments, archival message deposit confirmation for a subscriber may be based on a routing server acknowledgement—which is where the message archival routing server confirms to the IMS core that it has received the copy of the transmitted message for deposit, and is assuming responsibility for completing the task of depositing the copy of the transmitted message to the appropriate archive system endpoint. When the routing server acknowledgement scheme is active for a user, then the IMS core will accept the routing server acknowledgement for purposes of releasing the message for delivery to one or more message targets (MTs). In contrast, archival message deposit confirmation for a subscriber may be based on an archival endpoint acknowledgement—which is where the archive system endpoint confirms to the IMS core that it has received the copy of the transmitted message for deposit, and has completed the task of depositing the copy of the transmitted message. In some implementations, an IMS core and the archival routing server may be designed to support both routing server acknowledgement and archival endpoint acknowledgement options. The system logic dynamically adjusts based on the archival dependency value indicated in a subscriber profile, providing flexibility to accommodate varying levels of archival security.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network operating environment for a network-based messaging system that implements archival message deposit confirmation, in accordance with some embodiments;

FIG. 2 is a diagram illustrating an example data flow between a message archival routing server, and a message subscriber database that includes one or more subscriber archiving profiles, in accordance with some embodiments;

FIG. 3 is a diagram for an example data flow for archival message deposit confirmation, in accordance with some embodiments;

FIGS. 4A and 4B are example data flow diagrams illustrating archival message data routing for routing server dependency, in accordance with some embodiments;

FIGS. 5A and 5B are example data flow diagrams illustrating archival message data routing for archival endpoint dependency, in accordance with some embodiments;

FIG. 6 is a diagram illustrating an example telecommunications network environment comprising network functions for implementing an archiving messaging service with archival message deposit confirmation, in accordance with some embodiments;

FIG. 7 is a flow chart illustrating an example method for archival message deposit confirmation as performed by an IMS core and/or message hold-and-release function, according to some embodiments;

FIG. 8 is a flow chart illustrating an example method for archival message deposit confirmation as performed by a message archive routing server and/or adaptive deposit acknowledgement function, according to some embodiments;

FIG. 9 is a flow chart illustrating an example method for archival message deposit confirmation, according to some embodiments;

FIG. 10 is a diagram illustrating an example computing environment, in accordance with one embodiment; and

FIG. 11 is a diagram illustrating an example cloud computing environment, in accordance with some embodiments.

### DETAILED DESCRIPTION

Embodiments of the present disclosure provide for archival message deposit confirmation for messaging systems and applications. As further described herein, one or more of the embodiments presented in this disclosure may implement a logic that controls the messaging system to hold delivery of the message pending receipt of a positive deposit acknowledgement, and waits for such acknowledgement before releasing the message for delivery to the message target(s).

As the use of message archival services expands due to increasing compliance requirements for businesses, government agencies, and other entities, there is a growing need for solutions that can provide a high degree of assurance that electronic messages are archived when they need to be. With current message archival services available today, when a message is launched from a message originator (MO) for delivery to a message target (MT), if the archival service fails to successfully deposit a copy of a message to the archive, a compliance issue may arise in that a record of that message may be unavailable for regulatory review and audits.

A message archiving process at an IP Multimedia Subsystem (IMS) core may begin when a user, who has a subscription where the message archival service is enabled, originates a message. The user that originates a message may be referred to as a message originator (MO) and the intended recipient of the message (there may be one or more) referred to as a message target (MT). The process of an MO originating a message may be referred to as provisioning the message with the IMS core. The provisioned message is first sent to the IMS core for processing, where the IMS core checks a user provisioning database to verify if a user (either an MO or MT) is subscribed to archiving services. If the database confirms that the user is provisioned for message archival, a copy of the message is sent to the archival routing server. This archival routing server is responsible for handling the archival process, which includes copying the message and performing a partner identification (ID) lookup to determine the appropriate archive system endpoint for depositing an archived message. The endpoint can be either hosted internally (e.g., within the network of a mobile carrier) or externally by a third-party partner. For example, when an MO provisions a message for transmission to one or more MTs, the IMS core may transmit the message to a message routing server, which may then route the message data via a network (e.g., the Internet) to the user equipment (UE) of the one or more MTs. In this transmission from the MO to the MT(s), each of the MO and the MT(s) represents an endpoint of the message transmission with end-to-end encryption and authentication protocols (e.g., secure sockets layer (SSL), transport layer security (TLS), or mutual transport layer security (mTLS), etc.) applied between those endpoints. In some embodiments, routing of the transmitted message data to the MT(s) may be based on subscriber identifiers (ID(s)) (e.g., a phone number), where subscriber IDs may serve as a messaging network address associated with the user equipment (UE) of the MO and MT(s). With respect to archiving the transmitted message data, once the partner ID lookup is completed, the message content is sent to the identified archiving service endpoint for deposit. The archival routing server may be configured to send a positive response back to the IMS core to confirm a successful archival of the message. However, the IMS core does not wait for this positive response before proceeding with the delivery of the original message to the one or more MTs. The delivery of the original message continues independently of the archival process, with no dependency on the successful archiving for the message delivery.

In contrast to these prior message archiving systems, embodiments of the present disclosure provide for archival message deposit confirmation logic that may be integrated into a messaging system, to control the messaging system to hold delivery of a message while waiting for receipt of a positive deposit acknowledgement. The message may then be released for delivery upon the IMS core receiving the acknowledgement.

As explained herein, archival message deposit confirmation may be selectively based on different types of deposit acknowledgements depending on the degree of assurance that a message archiving system subscriber desires that user messages are being archived as intended. For example, in some embodiments, archival message deposit confirmation for a subscriber may be based on a routing server deposit acknowledgement—which is where the message archival routing server confirms to the IMS core that it has received the copy of the transmitted message for deposit, and is assuming responsibility for completing the task of depositing the copy of the transmitted message to the appropriate archive system endpoint. When the routing server acknowledgement scheme is active for a user, then the IMS core will accept the routing server acknowledgement for purposes of releasing the message for delivery to the MT(s). In contrast, in some embodiments, archival message deposit confirmation for a subscriber may be based on an archival endpoint deposit acknowledgement—which is where the archive system endpoint confirms to the IMS core that it has received the copy of the transmitted message for deposit, and has completed the task of depositing the copy of the transmitted message. When the archival endpoint acknowledgement scheme is active for a user, then the IMS core will accept the archival endpoint acknowledgement for purposes of releasing the message for delivery to the MT(s). In each case, if the appropriate deposit acknowledgement for the selected acknowledgement scheme is not received by the IMS core, then the provisioned message will not be delivered to the MT(s). In some embodiments, the IMS core may implement an acknowledgement timeout and void the provisioned message if the expected acknowledgement is not received within the timeout period. In some embodiments, a message transmittal failure may then be communicated as a notification from the IMS back to the MO.

As discussed in greater details herein, a routing server acknowledgement-based message archiving process begins when a user sends a message. The IMS core first checks the user provisioning database to verify if the user has the message archival service enabled. If the user is subscribed to this service, the IMS core checks an additional value from the profile to determine the user's archival dependency status, which can be set to indicate either a routing server or archive endpoint dependency. In this case, the archival dependency flag is set to “routing server.” The IMS core sends a copy of the message to the archival routing server, which manages connections to various partner endpoints and routes the message copy to the appropriate archival partner. If the message copy is not successfully deposited to the archival routing server, the server may employ a persistent retry function to deliver the message to the archive platform endpoint. That is, the server may store the copy of the message until the archive platform is ready to receive it, retrying delivery for at least a specified period of time (e.g., hours, days, or weeks). If the archival routing server successfully delivers the message to the partner endpoint, the routing server may send a positive deposit acknowledgement response to the IMS core, indicating successful archival. If the delivery to the partner endpoint fails, the server may queue the message and reply with a deposit queued acknowledgement response, indicating that the message is accepted and queued for delivery by the archive routing server. The IMS core may consider either response as a satisfactory positive deposit acknowledgement and then proceed with the delivery of the original message to the MT recipient. If the archival routing server fails to deliver a positive deposit acknowledgement, the IMS core halts message delivery to the MT and may report a failure to the user.

Similarly, as discussed in greater details herein, an archival endpoint acknowledgement-based message archiving process begins when a user sends a message. The IMS core may check the user provisioning database to verify if the user has the message archival service enabled. If the user is subscribed to this service, the IMS core checks an additional profile value to determine the user's archival dependency status, which is set to “endpoint archive.” In this case, the archival dependency flag is set to “endpoint archive” to indicate that the message must be successfully received for deposit at the archive platform endpoint before the original message can be delivered. The IMS core sends a copy of the message to the archival routing server. For a successful deposit to the archive platform endpoint, the archival server returns a positive endpoint deposit acknowledgement response to the IMS core, indicating successful archival. The IMS core may then proceed with the delivery of the original message to the MT recipient. In the event of a failure of the archive platform endpoint to deposit the message, the archival routing server may provide a negative deposit acknowledgement response to the IMS core. The IMS core, failing to obtain the positive deposit acknowledgement response, stops the delivery of the original message and may report a message delivery failure to the user. In various embodiments, the MO user may be notified of the failure through various mechanisms, such as synchronous responses, status messages, or bounce-back text messages.

In some implementations, the IMS core and the archival routing server are designed to support both routing server acknowledgement and archival endpoint acknowledgement options. The system logic dynamically adjusts based on the archival dependency value indicated in the subscriber profile, providing flexibility to accommodate varying levels of archival security. This adaptable dual-option approach allows messaging system customers to choose between a more forgiving archival process, which prioritizes reliable message delivery, and a stricter archival requirement, which may result in higher message delivery failures if the archival service encounters issues. The choice between these options depends on the customer's specific needs and preferences, balancing the importance of message archival integrity against the reliability of message delivery.

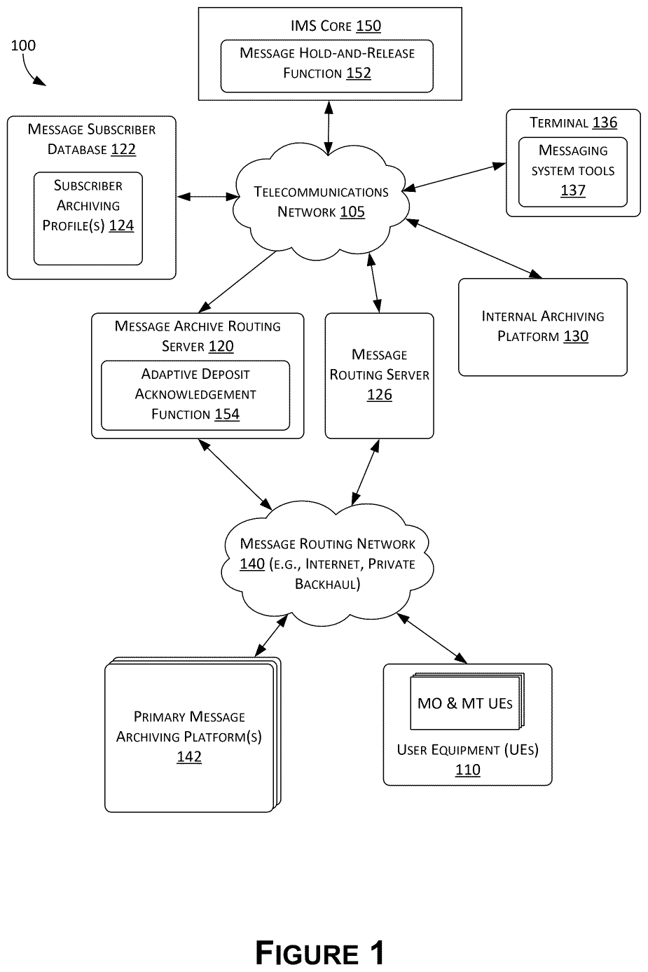

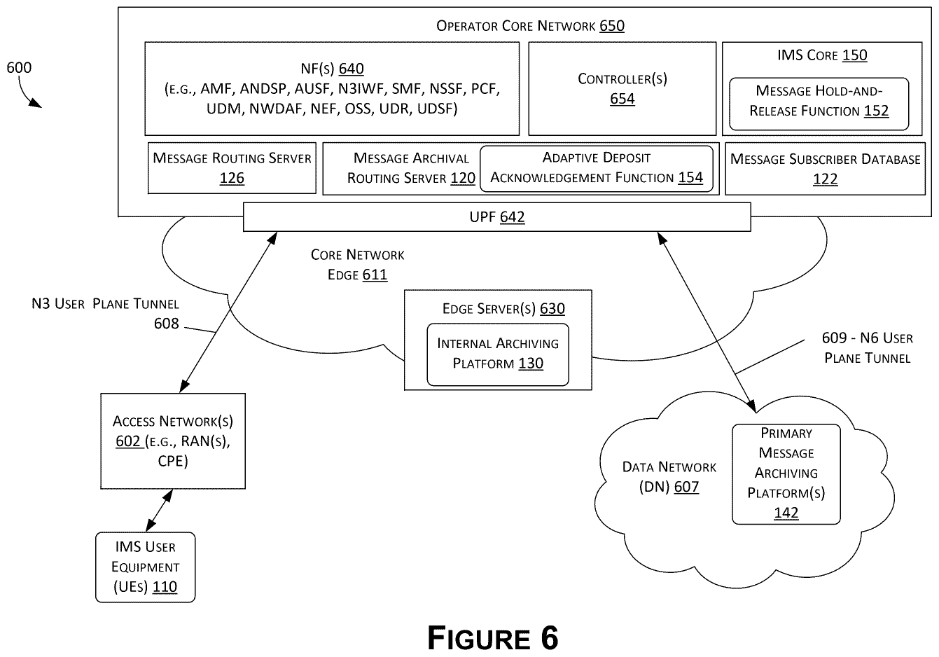

FIG. 1 is a diagram illustrating an example network operating environment 100, in accordance with some embodiments described herein. As shown in FIG. 1, operating environment 100 comprises an IP Multimedia Core Network Subsystem (IMS) core 150. In some embodiments, the IMS core 150 operates as a standardized architectural framework for a messaging system that facilitates the delivery of messages between an MO UE and one or more other MT UEs over a network (e.g., IP networks such as the Internet). The IMS core 150 may manage session control, authentication, and authorization, enabling users to access messaging services (e.g., Short Message Service (SMS), Multimedia Messaging Service (MMS), Rich Communication Services (RCS), Unstructured Supplementary Service Data (USSD) and/or other message exchange services) securely and efficiently. The IMS core 150 may also support interoperability between various service providers (e.g., such as but not limited to the session initiation protocol (SIP), allowing for a consistent user experience regardless of the underlying network infrastructure. By leveraging protocols like SIP (Session Initiation Protocol), the IMS core 150 ensures robust and scalable communication, making it a vital element in modern telecommunications. In some embodiments, the IMS core 150 may be implemented as a component network function of a telecommunications network operator core network (CN) 650, such as is shown and discussed below with respect to FIG. 6. With respect to messaging services, the IMS core 150 may function to transmit messages from user equipment (UE) 110 operating as the MO to one or more message target (MT) UEs 110.

For example, a UE 110 may comprise any form of a computing device comprising such as, but not limited to, workstations, desktop computers, laptop computers, smart phones, tablets, handheld and/or wearable computing devices, personal digital assistants, a fitness tracker, or any other device capable of communicating using one or more resources of the IMS core 150. The terms “user equipment,” “UE,” and/or “user device” are used interchangeably to refer to a device employed by an end user that communicates using a network. UE(s) 110 may therefore include components such as software and hardware, one or more processors (e.g., processing circuitry), a memory, a display component, a power supply or power source, a speaker, a touch-input component, a keyboard, and the like.

As shown in FIG. 1, the IMS core 150 may be coupled to a telecommunications network 105 (which may comprise at least in part the core network 650 and/or core network edge 611 as shown in FIG. 6) through which it communicates with one or more of a message routing server 126, a message archive routing server 120, a message subscriber database 122, an internal archiving platform 130, and/or a computing device 136 (e.g., a computer terminal 136). In some embodiments, the computing device 136 may run one or more messaging system tools 137, for example for accessing and/or configuring functions of the IMS core 150, message routing server 126, message archive routing server 120, message subscriber database 122, and/or other network functions or network services. Messaging system tools 137 may comprise one or more applications executed by the computing device 136 and/or one or more applications at least partially executed by cloud computing resources.

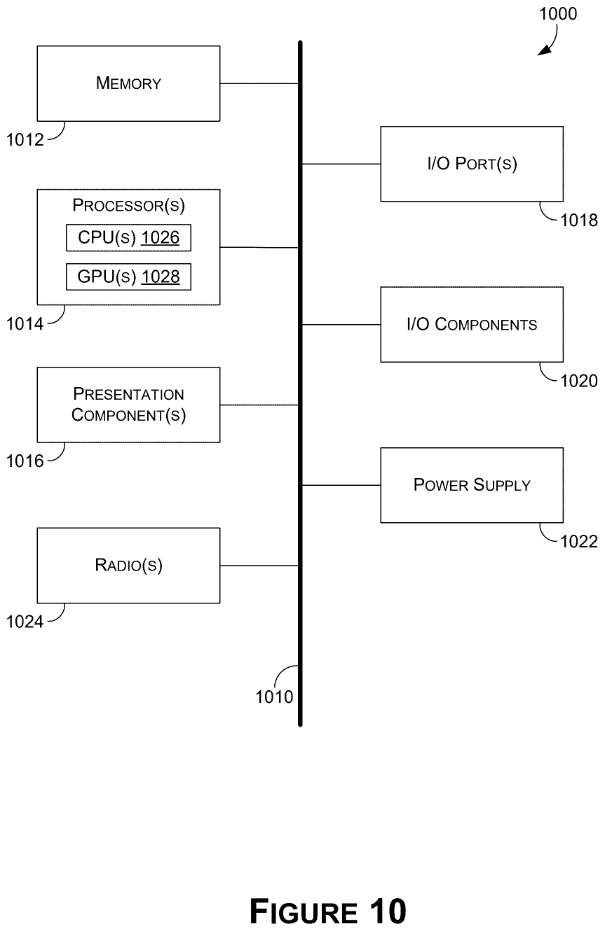

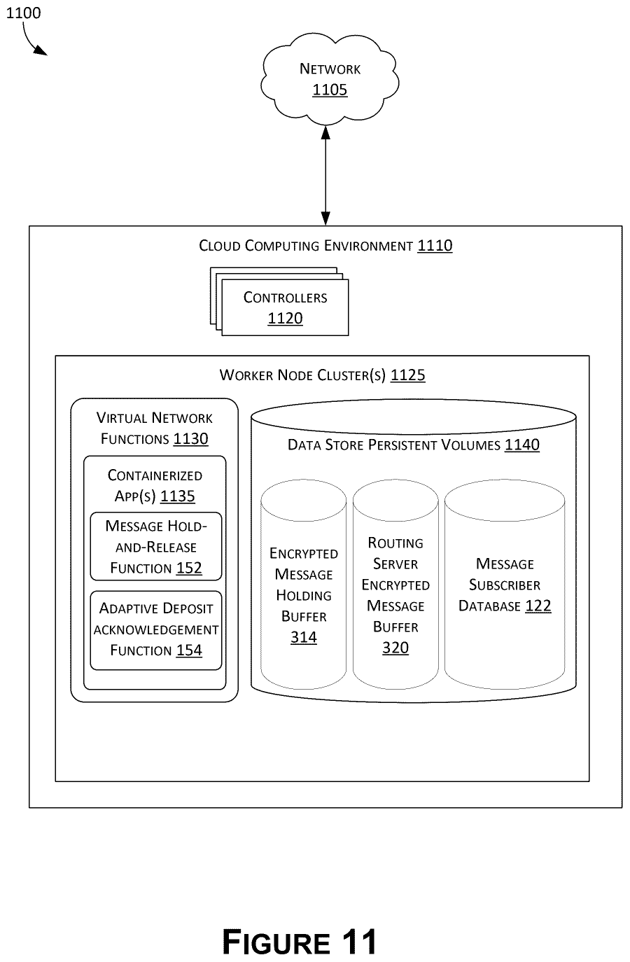

In some embodiments, the UE(s) 110 may comprise a wired or wireless network interface through which they communicate with the IMS core 150 through the message routing server 126, for example, via at least one message routing network 140. The at least one message routing network 140 may define a backhaul network, and may be implemented using one or more networks such as a cellular telecommunications network (e.g., a 4G LTE (4^{th} Generation Long Term Evolution) and/or a 5G NR (5^{th} Generation New Radio) network), the Internet, one or more public backhaul network(s), and/or one or more proprietary backhaul network(s). In some embodiments, one or more primary message archiving platform(s) 142 and/or at least one internal archiving platform 130 may communicate with the IMS core 150 through the message archive routing server 120, for example, via network 140 and/or network 105. In some embodiments, one or more functions of the IMS core 150, message routing server 126, message archive routing server 120, message subscriber database 122, and/or computing device 136 may comprise and/or be at least partially implemented using code executed by the computing device 1000 described with respect to FIG. 10, and/or components of the cloud computing platform 1100 described with respect to FIG. 11.

As shown in FIG. 1 and explained in greater detail herein, in some embodiments, the IMS core 150 may comprise a message hold-and-release function 152, and the message archive routing server 120 may comprise an adaptive deposit acknowledgement function 154, which may operate in conjunction with each other to implement the archival message deposit confirmation logic described herein.

When an MO provisions a message for transmission to an MT, the respective UE 110 of the MO encrypts the message content (e.g., using end-to-end encryption and authentication protocols (e.g., SSL, TLS, and/or mTLS) and transmits the encrypted message data to the IMS core 150. The transmitted message data may include the subscriber ID of the MO and may include the subscriber ID(s) of one or more MTs that are the intended recipient(s) of the message content (e.g., the transmitted message data). As previously mentioned, each of the MO and the MT(s) represents an endpoint of the message transmission with end-to-end encryption and authentication protocols applied between those endpoints.

Upon receiving transmitted message data at the IMS core 150, the message hold-and-release function 152 may query the message subscriber database 122 to obtain a subscriber archiving profile 124 to identify if one or more subscriber IDs associated with the message are provisioned for message archiving. If no subscriber ID associated with the message is provisioned for message archiving, the IMS core 150 may call on the message routing server 126 to route the transmitted message data via the message routing network 140 to the UE 110 of the one or more MTs. In some embodiments, routing of the transmitted message data to the UE 110 of the MT(s) may be based on subscriber ID(s) (e.g., a phone number), where subscriber IDs may serve as a messaging network address associated with the UE of the MO and MT(s). Replies (or other incoming messages) addressed for delivery to the MO may be similarly processed with the IMS core 150 receiving and forwarding the reply transmitted message data to the MO.

If instead one or more subscriber IDs associated with the message are provisioned for message archiving, then the IMS core 150 may call on the message archive routing server 120 to route the transmitted message data to one or more of the primary message archiving platform(s) 142 and/or an internal archiving platform 130, in accordance with the subscriber archiving profile 124. As discussed herein, because at least one subscriber ID associated with the message is provisioned for message archiving, the archival message deposit confirmation logic described herein is triggered. More specifically, when a message is provisioned for message archiving, the message hold-and-release function 152 will control the IMS core 150 to hold the message (e.g., in a message holding buffer)—delaying transmission of the message data to the MT(s) until a positive acknowledgement (either a positive routing server acknowledgement, or a positive archival endpoint acknowledgement) is obtained from the adaptive deposit acknowledgement function 154 of the message archive routing server 120. In some embodiments, if no positive deposit acknowledgement is received within a timeout period (or if a negative acknowledgement is received), then the message hold-and-release function 152 may respond by blocking transmission of the message to the MT(s).

The primary message archiving platform(s) 142 and/or internal archiving platform 130 shown in FIG. 1 may comprise one or more computing platforms (e.g., cloud-based network servers) that include message archiving service applications hosted by one or more network services, which may accept deposits of transmitted message data from the IMS core 150 (e.g., using one or more application programming interfaces (APIs)) for logging and/or archiving. When the IMS core 150 receives transmitted message data received from the UE 110 of the MO (or conversely receives an incoming message targeting that UE 110 of the MO), the IMS core 150 may call on the message archive routing server 120 to route the transmitted message data to one or more of the primary message archiving platform(s) 142 and/or internal archiving platform 130 in accordance with a subscriber archiving profile 124. In some embodiments, one or more functions of the primary message archiving platform(s) 142 and/or internal archiving platform 130 may comprise and/or be at least partially implemented using code executed by a computing device 1000 such as is described with respect to FIG. 10, and/or components of a cloud computing platform 1100 such as is described with respect to FIG. 11.

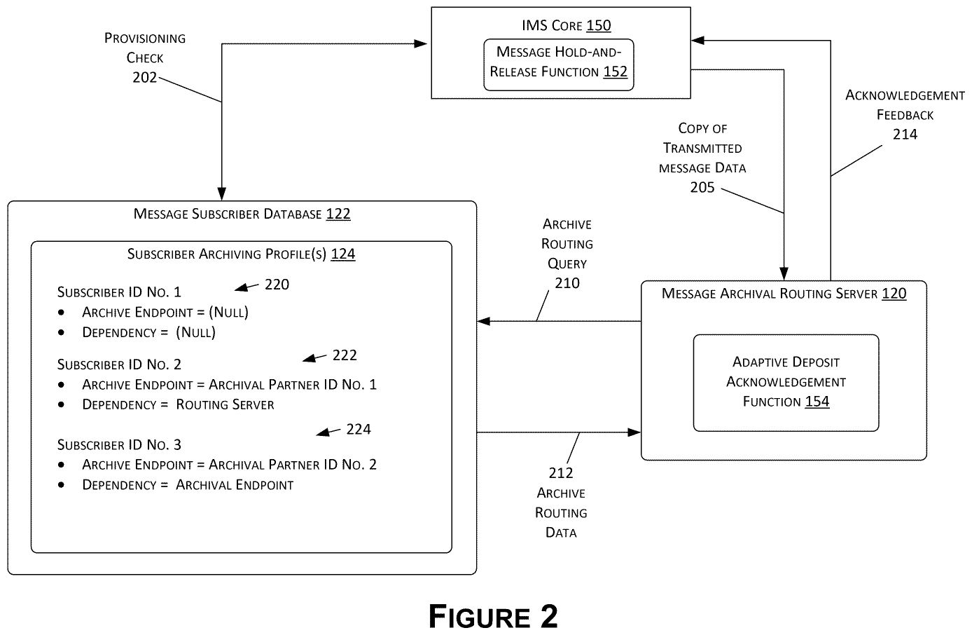

For example, as illustrated in FIG. 2, in response to receiving transmitted message data from an MO, the IMS core 150 may access the message subscriber database 122 to perform a provisioning check 202, which may be based on a subscriber ID associated with the MO and/or MT(s). In some embodiments, an individual subscriber archiving profile (shown by example at 220, 222, and 224) may be defined for a subscriber ID that indicates when a subscriber (MO and/or MT(s)) is provisioned for archiving services. For example, the subscriber archiving profile 220 for this subscriber ID (subscriber ID No. 1) lists a null value archive endpoint, indicating that messages for this subscriber ID are not archived (that is, the user is not provisioned for message archiving). As such, the message hold-and-release function 152 is not activated, and the IMS core 150 may proceed directly with forwarding the transmitted message data from the MO to the MT(s) via the message routing server 126. In contrast, the subscriber archiving profiles 222 and 224 both include non-null archive endpoint values. More specifically, the subscriber archiving profile 222 (for subscriber ID No. 2) includes an archive endpoint value that comprises an archival partner ID (archival partner ID No. 1) and further includes a “routing server” release dependency value indicating to the IMS core 150 that routing server acknowledgement message archiving is to be implemented for archiving messages with this archive endpoint. The subscriber archiving profile 224 (for subscriber ID No. 3) includes an archive endpoint value that comprises an archival partner ID (archival partner ID No. 2) and further includes an “archival endpoint” release dependency value indicating to the IMS core 150 that routing server acknowledgement message archiving is to be implemented for archiving messages with this archive endpoint. As such, for both subscriber archiving profile 222 and 224, the message hold-and-release function 152 will activate and control the IMS core 150 to hold the transmitted message data from the MO—and not forward the transmitted message data to the MT(s)—until the appropriate acknowledgement (e.g., shown as acknowledgement feedback 214) is received from the adaptive deposit acknowledgement function 154 as defined by the respective release dependency value.

With the provisioning check 202 completed, for transmitted message data where the user is has subscribed to message archiving, the IMS core 150 may send a message deposit request comprising a copy of the transmitted message data 205 (which carries the encrypted message content payload) to the message archive routing server 120. The message archive routing server 120 may respond to receiving the transmitted message data 205 by sending an archive routing query 210 to the message subscriber database 122 based on a subscriber ID (e.g., of the MO and/or MT(s)) included with the copy of the transmitted message data 205. As shown in FIG. 2, the message subscriber database 122 may include one or more subscriber archiving profiles 124 that may indicate which archiving platforms are used to deposit message archives by specifying a partner ID corresponding to a particular archiving platform. A subscriber archiving profile 124 may include a partner ID corresponding to a particular one or more primary message archiving platforms 142, internal archiving platform 130, or a combination of both. In some embodiments, the message subscriber database 122 may be integrated within the message archive routing server 120.

As further discussed herein, a message archive routing server 120 may include adaptive deposit acknowledgement function 154 that reads a subscriber archiving profile 124 for a subscriber ID and configures the message archive routing server 120 to route the copy of the transmitted message data 205 to the archiving platform(s) indicated by the partner ID(s). For example, the subscriber archiving profile 222 indicates that transmitted message data 205 associated with subscriber ID No. 2 should be routed to the message archiving platform that is assigned archival partner ID No. 1. Similarly, transmitted message data 205 associated with subscriber ID No. 3 should be routed to a message archiving platform that is assigned archival partner ID No. 2. The message subscriber database may respond to the query 210 by sending archive routing data 212 back to the message archive routing server 120. The archive routing data 212 may include, for example, a partner ID, phone number, and/or other network address indicating where the transmitted message data 205 is to be routed for archiving, and the message archive routing server 120 may then route the copy of the transmitted message data 205 via message routing network 140 to the appropriate message archive for archiving. In this transmission from the MO to the message archive platforms indicated by the subscriber archiving profiles 124, each of the MO and the message archive platforms represents an endpoint of the message transmission with end-to-end encryption and authentication protocols (e.g., SSL, TLS, and/or mTLS) applied between those endpoints.

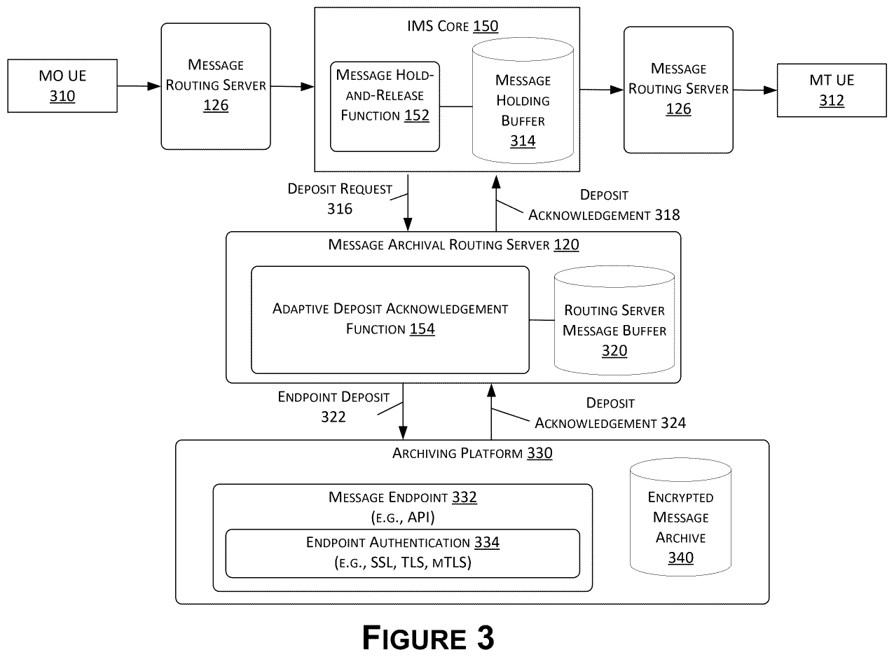

FIG. 3 is a data flow diagram generally illustrating the interaction between the message hold-and-release function 152 and the adaptive deposit acknowledgement function 154 in implementing archival message deposit confirmation logic in accordance with one or more embodiments of this disclosure. As shown in FIG. 3, message provisioning may be initiated by an MO UE 310 by transmitting message data, via the message routing server 126, to the IMS core 150. If message archiving has not been provisioned for this MO or for the destination MT UE 312, then the message hold-and-release function 152 of the IMS core 150 is not activated and the transmitted message data is forwarded by the IMS core 150, via the message routing server 126, to the MT UE 312.

In the case where message archiving has been provisioned for this MO and/or MT, then the IMS core 150 activates the message hold-and-release function 152 to store a copy of the transmitted message data to the message holding buffer 314, pending receipt of a deposit acknowledgement 318 (e.g., a router server or endpoint acknowledgement) as specified by the corresponding subscriber archiving profile 124, as discussed with respect to FIG. 2.

As shown in FIG. 3, with the message hold-and-release function 152 and the transmitted message data held within (stored to) the message holding buffer 314, the IMS core 150 may proceed to send a deposit request 316 to the message archive routing server 120, where the deposit request 316 carries the copy of transmitted message data 205 shown in FIG. 2. The message archive routing server 120 accesses the subscriber archiving profile 124 for one or more of the subscriber IDs associated with the deposit request 316 (e.g., subscriber ID(s) for the MO and/or MT(s)) and sends the copy of the transmitted message data as an endpoint deposit request 322 to the archiving platform 330 indicated by a partner ID from the subscriber archiving profile 124.

In some embodiments, the archiving platform 330 may include a message endpoint 332 that operates as an interface to receive the transmitted message data 205 from the message archive routing server 120. The message endpoint 332 may comprise an API that mimics the functionality of an authorized message endpoint. For example, in some embodiments, the message endpoint 332 may include an endpoint authentication 334 function that performs an SSL protocol handshake (and/or other end-to-end encryption and authentication protocols such as, but not limited to, SSL, TLS, and/or mTLS) with the IMS core 150 and/or UE 110 of the MO. In some embodiments, the archiving platform 330 may store the encrypted transmitted message data to an encrypted message archive 340 (e.g., a database or other storage device)—from which the stored transmitted message data may be accessible to organizations to meet regulatory compliance, auditing, and legal requirements and/or to assist in troubleshooting tasks. In some embodiments, authorized personnel may use the computer terminal 136 (e.g., via system tools 137) to access one or more functions of the archiving platform 330, such as accessing transmitted message data from the encrypted message archive 340.

In accordance with one or more embodiments of this disclosure, the adaptive deposit acknowledgement function 154 may control the message archive routing server 120 to output a deposit acknowledgement 318 to the IMS core 150. The contents of the deposit acknowledgement 318 may vary based on a deposit acknowledgement 324 provided by the archiving platform 330 and the release dependency value provided by the subscriber archiving profile 124. For example, in some embodiments, the archiving platform 330 may provide a positive deposit acknowledgement 324 back to the message archive routing server 120, which is processed by the adaptive deposit acknowledgement function 154. Such a positive deposit acknowledgement 324 may indicate that the endpoint deposit request 322 was successfully received and processed by the archiving platform 330 (e.g., a copy of the message was archived to the encrypted message archive 340). In that case, the adaptive deposit acknowledgement function 154 may generate a positive deposit acknowledgement 318 to the IMS core 150 that indicates a successful deposit of the message to the archiving platform 330. Based on such a positive deposit acknowledgement 318, the message hold-and-release function 152 may release the transmitted message data from the message holding buffer 314 to complete transmission of the message from the MO UE 310 to the MT UE 312.

If the adaptive deposit acknowledgement function 154 does not receive a positive deposit acknowledgement 324 from the archiving platform 330 (e.g., a positive acknowledgement is not received within a timeout period, or a negative acknowledgement is instead received), then the adaptive deposit acknowledgement function 154 may determine the appropriate deposit acknowledgement 318 to produce based on the dependency value indicated in the subscriber archiving profile 124.

For example, in some embodiments the release dependency value provided by the subscriber archiving profile 124 may indicate an archival endpoint dependency (e.g., as shown at 224 in FIG. 2). For archival endpoint dependency, in the event that the adaptive deposit acknowledgement function 154 fails to receive a positive deposit acknowledgement 324, the message archive routing server 120 sends a deposit acknowledgement 318 that includes an error response. Failure to receive a positive deposit acknowledgement 324 may occur, for example, where the archiving platform 330 fails to receive the endpoint deposit 322 and/or where the archiving platform 330 receives the message endpoint 332 but otherwise does not return a positive deposit acknowledgement 324, indicating a successful deposit of the transmitted message data. In some embodiments, the error response may comprise a negative acknowledgement 318. In some embodiments, the error response may include not sending any form of deposit acknowledgement 318 to the IMS core 150, in which case the message hold-and-release function 152 may interpret the failure to receive a deposit acknowledgement 318 (e.g., within a timeout period) as a negative response. Based on the failure of receiving a positive deposit acknowledgement 318 in response to sending a deposit request 316 (when archival endpoint dependency is specified), the message hold-and-release function 152 may block the forwarding of the transmitted message data to the MT UE 312, and in some embodiments may purge the transmitted message data from the message holding buffer 314. In some embodiments, the message hold-and-release function 152 may send the MO UE 310 a notification that the message provisioned by the MO was not successfully delivered to the MT (e.g., using a synchronous response, status messages, and/or bounce-back text message).

In some embodiments, the release dependency value provided by the subscriber archiving profile 124 may indicate a routing server dependency (e.g., as shown at 222 in FIG. 2). For routing server dependency, in the event that the adaptive deposit acknowledgement function 154 fails to receive a positive deposit acknowledgement 324, the message archive routing server 120 may queue a copy of the transmitted message data to a routing server message buffer 320 and cache the message data until the archiving platform 330 is ready to receive it. For example, the adaptive deposit acknowledgement function 154 may cache the transmitted message data to the routing server message buffer 320 for a specified period (e.g., hours, days, or weeks) while executing a persistent retry function that repeatedly attempts to transmit endpoint deposit 322 and receive a positive deposit acknowledgement 324 in response. As discussed above, if the message archive routing server 120 successfully delivers the message to the archiving platform 330, the message archive routing server 120 may send a positive deposit acknowledgement 318 response (e.g., a 200 message) to the IMS core 150, indicating successful archival. However, with routing server dependency, when the adaptive deposit acknowledgement function 154 cannot determine that delivery to the archiving platform 330 was successful (e.g., no positive deposit acknowledgement 324) and instead has cached the transmitted message data to the routing server message buffer 320, then the adaptive deposit acknowledgement function 154 may generate a deposit acknowledgement 318 that comprises a cached deposit acknowledgement response.

With the message flagged by the subscriber archiving profile 124 as a routing server dependency, the message hold-and-release function 152 will accept a deposit acknowledgement 318 comprising either a positive deposit acknowledgement 318, or a cached deposit acknowledgement response 318, as a trigger to release the message from the message holding buffer 314 and complete transmission of the message from the MO UE 310 to the MT UE 312. If the message archive routing server 120 does not provide either a positive deposit acknowledgement or a cached deposit acknowledgement response, the message hold-and-release function 152 may block the forwarding of the transmitted message data to the MT UE 312, and in some embodiments may purge the transmitted message data from the message holding buffer 314. In some embodiments, the message hold-and-release function 152 may send the MO UE 310 a notification that the message provisioned by the MO was not successfully delivered to the MT (e.g., using a synchronous response, status messages, and/or a bounce-back text message).

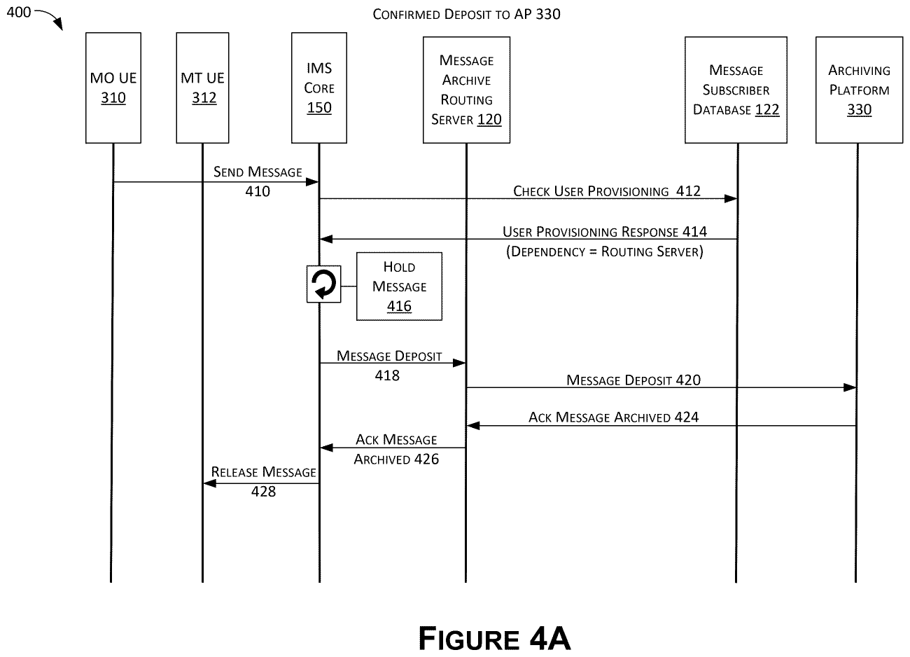

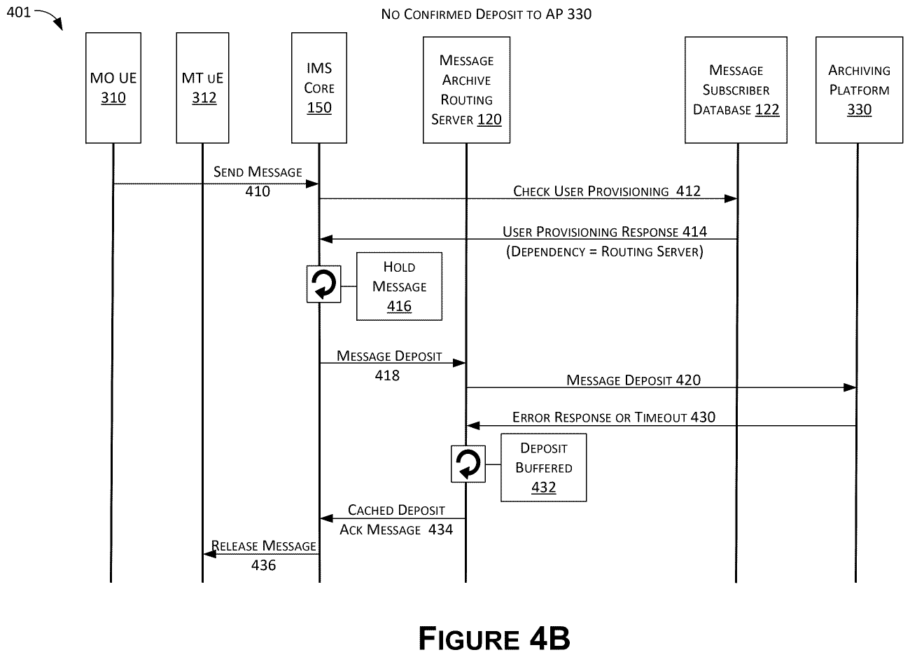

Now referring to FIG. 4A, an example data flow 400 is illustrated representing an archival message deposit confirmation logic embodiment implementing router server dependency. Such a configuration may be used, for example, where delivery of a message from an MO to an MT may have time-critical considerations that outweigh stringent confirmation that the message has been archived. In some embodiments, the archival message deposit confirmation logic may be implemented based on the interaction between the message hold-and-release function 152 of IMS core 150 and the adaptive deposit acknowledgement function 154 of message archive routing server 120, as previously illustrated in FIG. 3. As shown in FIG. 4A, the MO UE 310 may initiate message provisioning as shown at 410 by sending a message to the IMS core 150. The IMS core 150 may then call on the message subscriber database 122 to check for user provisioning (as shown at 412) by evaluating the subscriber archiving profile 124 for one or more subscriber IDs associated with the transmitted message (e.g., the subscriber ID of the MO and/or of the MT(s)). The IMS core 150 may review the archival endpoint value and/or release dependency value provided by the subscriber archiving profile 124 to determine if message archiving is provisioned for the transmitted message, and if so, whether router server dependency or archival endpoint dependency applies. In the example of FIG. 4A, a user provisioning response 414 is transmitted by the message subscriber database 122 to the IMS core 150 that indicates that message archiving is provisioned and further specifies the use of router server dependency. Based on the indication that message archiving is provisioned, the IMS core 150 (e.g., the message hold-and-release function 152) may hold the message (shown at 416) pending receipt of a deposit acknowledgement 318. For example, the message hold-and-release function 152 may queue the transmitted message data to the message holding buffer 314. The IMS core 150 may then proceed to forward a copy of the transmitted message data to the message archive routing server 120 for deposit to the archiving platform 330. The message archive routing server 120 may in turn forward the transmitted message data to the archiving platform 330 for deposit, as shown at 420. In the example of FIG. 4A, the transmitted message data is successfully received and deposited by the archiving platform 330 so that the archiving platform 330 provides a positive deposit acknowledgement that the message is archived (shown at 424) to the message archive routing server 120, which in turn provides a positive deposit acknowledgement that the message is archived (shown at 426) to the IMS core 150. Based on this positive deposit acknowledgement, the IMS core 150 releases the message for transmission to the MT UE 312, as shown at 428.

Referencing FIG. 4B, an example data flow 401 is illustrated representing an archival message deposit confirmation logic embodiment implementing router server dependency, except that in contrast to FIG. 4A, in the example of FIG. 4B, a positive acknowledgement is not received from the archiving platform 330. In this example, the MO UE 310 may initiate message provisioning as shown at 410 by sending a message to the IMS core 150. The IMS core 150 may then call on the message subscriber database 122 to check for user provisioning (as shown at 412) by evaluating the subscriber archiving profile 124 for one or more subscriber IDs associated with the transmitted message (e.g., the subscriber ID of the MO and/or of the MT(s)). The IMS core 150 may review the archival endpoint value and/or release dependency value provided by the subscriber archiving profile 124 to determine if message archiving is provisioned for the transmitted message, and if so, whether router server dependency or archival endpoint dependency applies. The user provisioning response 414 is transmitted by the message subscriber database 122 to the IMS core 150 that indicates that message archiving is provisioned and further specifies the use of router server dependency. Based on the indication that message archiving is provisioned, the IMS core 150 (e.g., the message hold-and-release function 152) may hold the message (shown at 416) pending receipt of a deposit acknowledgement 318. For example, the message hold-and-release function 152 may queue the transmitted message data to the message holding buffer 314. The IMS core 150 may then proceed to forward a copy of the transmitted message data (shown at 418) to the message archive routing server 120 for deposit to the archiving platform 330. The message archive routing server 120 may in turn forward the transmitted message data to the archiving platform 330 for deposit, as shown at 420. In the example of FIG. 4B, the message archive routing server 120 does not receive a positive acknowledgement from the archiving platform 330. Instead, as shown at 430, the archiving platform 330 may either send a negative acknowledgement (indicating that a problem occurred with message archiving) or may not send any form of acknowledgement, which the adaptive deposit acknowledgement function 154 may interpret the lack of a response as an error response after a timeout period elapses. For routing server dependency, in the event that the adaptive deposit acknowledgement function 154 fails to receive a positive deposit acknowledgement from the archiving platform 330, the message archive routing server 120 may queue a copy of the transmitted message data to a routing server message buffer (as shown at 432) and cache the message data until the archiving platform 330 is ready to receive it. With routing server dependency, confirmation that the transmitted message data has been cached to a routing server message buffer is considered a sufficient confirmation to release the message from the IMS core 150. As such, the message archive routing server 120 transmits a cached deposit acknowledgement response (shown at 434). That is, with routing server dependency, when the adaptive deposit acknowledgement function 154 cannot determine that delivery to the archiving platform 330 was successful, but instead has cached the transmitted message data to the routing server message buffer, then the adaptive deposit acknowledgement function 154 may generate a deposit acknowledgement 318 that comprises a cached deposit acknowledgement response (shown at 434). Based on this cached deposit acknowledgement response, the IMS core 150 releases the message for transmission to the MT UE 312, as shown at 436.

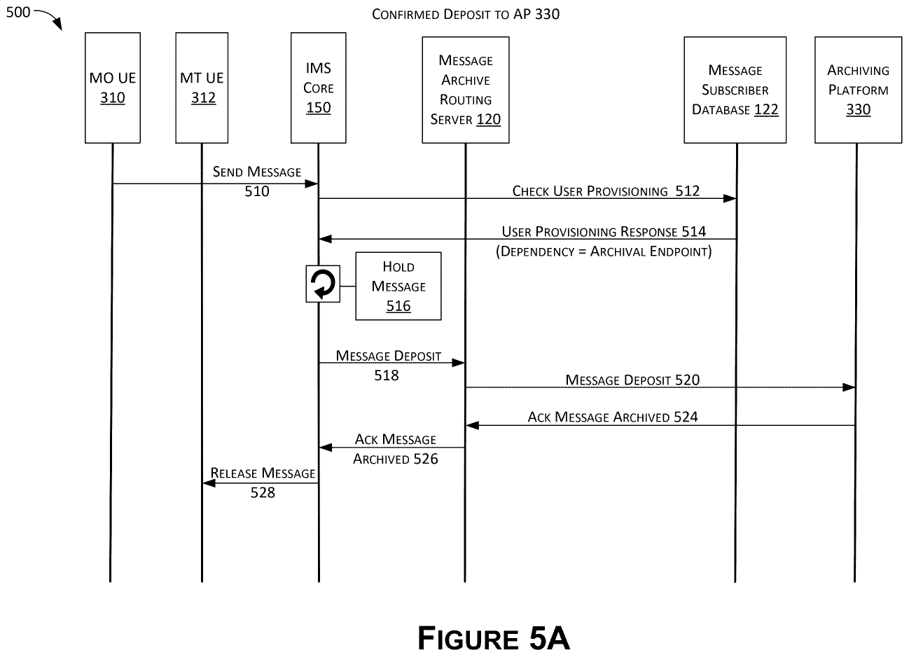

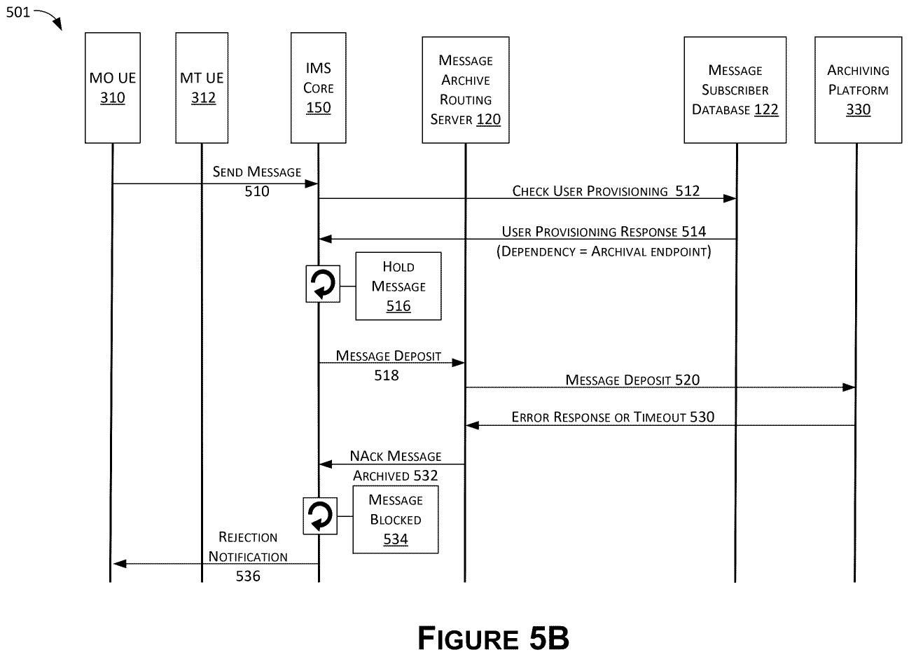

Now referring to FIG. 5A, an example data flow 500 is illustrated representing deposit confirmation logic embodiment implementing archival endpoint dependency. Such a configuration may be used, for example, where strict messaging archiving compliance may outweigh prompt message delivery considerations. In some embodiments, the archival message deposit confirmation logic may be implemented based on the interaction between the message hold-and-release function 152 of IMS core 150 and the adaptive deposit acknowledgement function 154 of message archive routing server 120, as previously illustrated in FIG. 3.

As shown in FIG. 5A, the MO UE 310 may initiate message provisioning as shown at 510 by sending a message to the IMS core 150. The IMS core 150 may then call on the message subscriber database 122 to check for user provisioning (as shown at 412) by evaluating the subscriber archiving profile 124 for one or more subscriber IDs associated with the transmitted message (e.g., the subscriber ID of the MO and/or of the MT(s)). The IMS core 150 may review the archival endpoint value and/or release dependency value provided by the 124 to determine if message archiving is provisioned for the transmitted message, and if so, whether router server dependency or archival endpoint dependency applies. In the example of FIG. 5A, a user provisioning response 514 is transmitted by the message subscriber database 122 to the IMS core 150 that indicates that message archiving is provisioned and further specifies the use of archival endpoint dependency. Based on the indication that message archiving is provisioned, the IMS core 150 (e.g., the message hold-and-release function 152) may hold the message (shown at 516) pending receipt of a deposit acknowledgement 318. For example, the message hold-and-release function 152 may queue the transmitted message data to the message holding buffer 314. The IMS core 150 may then proceed to forward a copy of the transmitted message data to the message archive routing server 120 (shown at 518) for deposit to the archiving platform 330. The message archive routing server 120 may in turn forward the transmitted message data to the archiving platform 330 for deposit, as shown at 520. In the example of FIG. 5A, the transmitted message data is successfully received and deposited by the archiving platform 330 so that the archiving platform 330 provides a positive acknowledgement that the message is archived (shown at 524) to the message archive routing server 120, which in turn provides a positive acknowledgement that the message is archived (shown at 526) to the IMS core 150. Based on this positive deposit acknowledgement, the IMS core 150 releases the message for transmission to the MT UE 312, as shown at 528.

Referencing FIG. 5B, an example data flow 501 is illustrated representing an archival message deposit confirmation logic embodiment implementing archival endpoint dependency, except that in contrast to FIG. 5A, in the example of FIG. 5B, a positive acknowledgement is not received from the archiving platform 330. In this example, the MO UE 310 may initiate message provisioning as shown at 510 by sending a message to the IMS core 150. The IMS core 150 may then call on the message subscriber database 122 to check for user provisioning (as shown at 512) by evaluating the subscriber archiving profile 124 for one or more subscriber IDs associated with the transmitted message (e.g., the subscriber ID of the MO and/or of the MT(s)). The IMS core 150 may review the archival endpoint value and/or release dependency value provided by the subscriber archiving profile 124 to determine if message archiving is provisioned for the transmitted message, and if so, whether router server dependency or archival endpoint dependency applies. The user provisioning response 514 is transmitted by the message subscriber database 122 to the IMS core 150 that indicates that message archiving is provisioned and further specifies the use of archival endpoint dependency. Based on the indication that message archiving is provisioned, the IMS core 150 (e.g., the message hold-and-release function 152) may hold the message (shown at 516) pending receipt of a deposit acknowledgement 318. For example, the message hold-and-release function 152 may queue the transmitted message data to the message holding buffer 314. The IMS core 150 may then proceed to forward a copy of the transmitted message data to the message archive routing server 120 for deposit to the archiving platform 330. The message archive routing server 120 may in turn forward the transmitted message data to the archiving platform 330 for deposit, as shown at 520. In the example of FIG. 5B, the message archive routing server 120 does not receive a positive acknowledgement from the archiving platform 330. Instead, as shown at 530, the archiving platform 330 may either send a negative acknowledgement (indicating that a problem occurred with message archiving) or may not send any form of acknowledgement, where the adaptive deposit acknowledgement function 154 may interpret the lack of a response as an error response after a timeout period elapses. For archival endpoint dependency, in the event that the adaptive deposit acknowledgement function 154 fails to receive a positive deposit acknowledgement from the archiving platform 330, the message archive routing server 120 may send a negative acknowledgement to the IMS core 150, as shown at 532. Based on the failure of receiving a positive deposit acknowledgement from the message archive routing server 120, the message hold-and-release function 152 of the IMS core 150 may block the forwarding of the transmitted message data (shown at 534) to the MT UE 312, and in some embodiments may purge the transmitted message data from the message holding buffer 314. In some embodiments, the message archive routing server 120 may send the MO UE 310 a rejection notification (shown at 536) indicating that the message provisioned by the MO was not successfully delivered to the MT UE 312 (e.g., using a synchronous response, status messages, and/or a bounce-back text message).

Referring now to FIG. 6, FIG. 6 is a diagram illustrating an example telecommunications network environment 600 implementing the messaging services with archival message deposit confirmation logic described herein, including the IMS core 150, message hold-and-release function 152, message routing server 126, message archive routing server 120, adaptive deposit acknowledgement function 154, message subscriber database 122, primary message archiving platform(s) 142, and/or internal archiving platform 130, which may be implemented as network functions of an operator core network 650 and made available as network services.

For example, in some embodiments, a message initiated by an MO from a UE 110 may be received by the operator core network 650 via the N3 user plane tunnel 608 and user plane function (UPF) 642 and forwarded to the IMS core 150 for processing as described herein. In some embodiments, the message hold-and-release function 152 and/or adaptive deposit acknowledgement function 154 may respond to application programming interface (API) calls from the IMS core 150 to process message deposits and/or acknowledgements as described herein based on the subscriber archiving profile 124 associated with the message (e.g., to determine whether message archiving applies to the message and/or whether router server dependency or archival endpoint dependency applies). In some embodiments, the IMS core 150 may call the message subscriber database 122 to read a subscriber archiving profile 124 associated with the message to determine whether message archiving applies to the message and/or whether router server dependency or archival endpoint dependency applies. The IMS core 150 may then operate the message hold-and-release function 152 to buffer the message data pending the appropriate acknowledgement (e.g., depending on whether router server dependency or archival endpoint dependency applies). Similarly, the message archive routing server 120 may call the message subscriber database 122 to read a subscriber archiving profile 124 associated with the message to determine a partner ID for the archiving platform to be used for archiving the message, and also to determine whether router server dependency or archival endpoint dependency applies, as described herein.

Network environment 600 is but one example of a suitable telecommunications network to implement archival message deposit confirmation logic and is not intended to suggest any limitation as to the scope of use or functionality of the embodiments disclosed herein, and nor should the network environment be interpreted as having any dependency or requirement relating to any one or combination of components illustrated. As shown in FIG. 6, network environment 600 comprises an operator core network 650 (also referred to as a “core network”) that provides one or more network services to one or more UEs (such as UEs 110) via at least one access network 602 (e.g., a radio access network (RAN)). In some embodiments, network environment 600 comprises, at least in part, a wireless communications network, such as, but not limited to, a 4G wireless communications network and/or a 5G wireless communications network. In some embodiments, the access network(s) 602 of network environment 600 comprises one or more RANs, which may be referred to in the context of a wireless telecommunications network as a wireless base station, cell site, or cellular base station. At least one RAN may represent at least one wireless base station coupled to the operator core network 650 to establish one or more communication links between the operator core network 650 and UE 110. Each RAN may provide wireless connectivity access to one or more UEs 110 operating within one or more coverage areas associated with a particular RAN. The RAN may implement wireless connectivity using, for example, 3rd Generation Partnership Project (3GPP) technologies. One or more of the access network(s) 602 may be referred to as an eNodeB in the context of a 4G Long-Term Evolution (LTE) implementation, a gNodeB in the context of a 5G New Radio (NR) implementation, or other terminology depending on the specific implementation technology. In some embodiments, access networks 602 may comprise, at least in part, components of a customer premises network, such as a distributed antenna system (DAS), for example, or other similar customer premises equipment (CPE). When an access network 602 is implemented as a RAN, the RAN may comprise a multimodal network (for example, comprising one or more multimodal access devices) where multiple radios supporting different systems are integrated into the RAN. Such a multimodal access network may support a combination of 3GPP radio technologies (e.g., 4G, 5G, and/or 6G) and/or non-3GPP radio technologies (e.g., Institute of Electrical and Electronics Engineers (IEEE) 802.11 (WiFi) and/or IEEE 802.15 (Bluetooth) access points). In some embodiments, access network(s) 602 may comprise a terrestrial wireless communications base station and/or may be at least in part implemented as a space-based access network, such as a base station implemented by an Earth-orbiting satellite. Individual UEs 110 may communicate with the operator core network 650 via the access network(s) 602 over one or both of uplink (UL) radio frequency (RF) signals and downlink (DL) radio frequency (RF) signals.

As shown in FIG. 6, access networks 602 may be coupled to the operator core network 650 via a core network edge 611 that comprises one or more edge servers 630 and wired and/or wireless network connections that may further include wireless relays and/or repeaters. In some embodiments, the access networks 602 may be coupled to the operator core network 650 at least in part by a backhaul network such as the Internet or other public or private network infrastructure. Core network edge 611 may comprise one or more network nodes (e.g., servers) or other elements of the operator core network 650 that may define the boundary of the operator core network 650 and may serve as the architectural demarcation point where the operator core network 650 connects to other networks such as, but not limited to, access networks 602, the Internet, a Data Network (DN) 607, and/or other third-party networks. In some embodiments, DN 607 may include one or more data stores and/or one or more cloud-based servers such that UE 110 may access services and/or content provided by the data store(s) and/or server(s) of DN 607. In some embodiments, one or more of the primary message archiving platform(s) 142 may be network nodes or elements within the DN 607 and/or may be coupled to the operator core network 650 at least in part by a backhaul network such as the Internet or other public or private network infrastructure.

In some embodiments, the network edge 611 may comprise one or more network nodes that include at least one edge server 630 that hosts an internal archiving platform 130 as discussed herein. As such, the internal archiving platform 130, as well as transmitted message data sent and deposited to the internal archiving platform 130, may remain within the trusted bounds of the operator core network 650 and/or core network edge 611 of the operator core network 650. In some embodiments, one or more edge server(s) 630 may provide, for example, edge-based network function services to UEs 110 that may be accessed separately from services provided by network functions of the operator core network 650. For example, edge server(s) 630 may host databases, caches, microservices, ledgers, decentralized applications (e.g., DApps), and/or may perform data traffic monitoring, inspections, and/or aggregation for other network functions of the network environment 600. In some embodiments, one or more functions performed by the IMS core 150, message hold-and-release function 152, adaptive deposit acknowledgement function 154, message archive routing server 120, message subscriber database 122, and/or message routing server 126 may be implemented as network functions by server applications hosted by one or more of the edge servers 630.

It should be understood that in some embodiments, the network environment 600 may not comprise a distinct operator core network 650, but rather may implement one or more features of the operator core network 650 within other portions of the network, or may not implement them at all, depending on various carrier preferences. In some implementations, the operator core network 650 may comprise modules, also referred to as network functions (NFs), implemented by one or more processors and generally represented in FIG. 6 as NF(s) 640. Such network functions 640 may include one or more of, but are not limited to, a core access and mobility management function (AMF), an access network discovery and selection policy (ANDSP), an authentication server function (AUSF), a user plane function (UPF), non-3GPP interworking function (N3IWF), a session management function (SMF), a network slice selection function (NSSF), a policy control function (PCF), a unified data management (UDM) function, a unified data repository (UDR), an unstructured data storage function (UDSF), a network data analytics function (NWDAF), a network exposure function (NEF), an operations support system (OSS), and/or other network functions. In some embodiments, the Operator Core Network 650 and/or IMS core 150 may comprise other network functions such as, but not limited to, a home subscriber server (HSS) and/or a user profile server function (UPSF). The HSS and/or UPSF may comprise a user database (e.g., subscriber IDs and/or partner IDs) that supports the IMS network entities that actually handle calls between UEs 110. In some embodiments, the database may include subscription-related information (e.g., subscriber profiles such as subscriber archiving profiles 124) that is used to perform authentication and authorization of users, and can provide information about the subscriber's location and IP information.

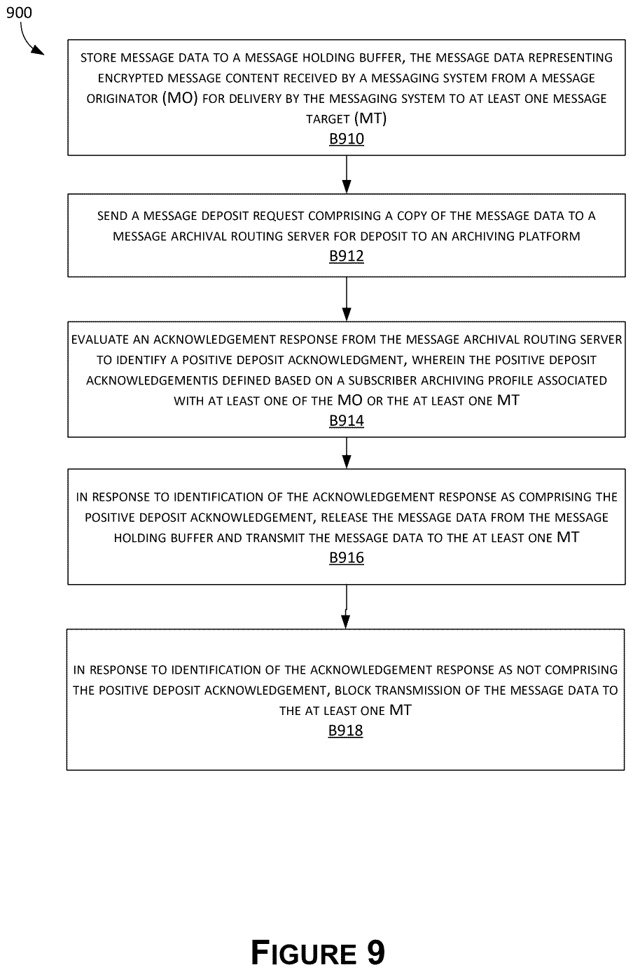

The internal archiving platform 130, which may be hosted on one or more edge servers 630 and/or other server nodes of the operator core network 650, may be implemented as a containerized function within the telecommunications network environment 600 (e.g., as illustrated in FIG. 9) as an internal service or endpoint, to replicate what a primary message archiving platform 142 endpoint would do with respect to receiving deposits of transmitted message data (e.g., establish a secure connection with the message archive routing server 120 to ingest message archival content).

Implementation of these NFs 640 of the operator core network 650 may be executed by one or more controllers 654 on which these network functions are orchestrated or otherwise configured to execute utilizing processors and memory of the one or more controllers 654. The NFs may be implemented as physical and/or virtual network functions, container network functions, and/or cloud-native network functions, such as is described with respect to FIG. 11.

The user plane function (UPF), illustrated in FIG. 6 at 642, represents at least one function of the operator core network 650 that may extend into the core network edge 611. In some embodiments, the access network 602 is coupled to the UPF 642 within the core network edge 611 by a communication link that includes an N3 user plane tunnel 608. For example, the N3 user plane tunnel 608 may connect a cell site router of the access network 602 to an N3 interface of the UPF 642. In some embodiments, transmitted message data as discussed herein may be communicated between UEs 110 and components of the operator core network 650 through the N3 user plane tunnel 608. The data store(s), server(s), and/or other elements of DN 607 (including, for example, primary message archiving platform(s) 142) may be coupled to the UPF 642 in the core network edge 611 by an N6 user plane tunnel 609. For example, the N6 user plane tunnel 609 may connect a network interface (e.g., a switch, router, and/or gateway) of the DN 607 to an N6 interface of the UPF 642. In some embodiments, transmitted message data as discussed herein may be communicated between message archive routing server 120 and the primary message archiving platform(s) 142 through the N6 user plane tunnel 609. In some embodiments, the operator core network 650 may comprise a plurality of UPFs 642, such as a UPF at the operator core network 650 and a UPF at the core network edge 611. For example, a UPF at the core network edge 611 may be used for local breakout and/or low-latency types of applications via an N9 interface between the distinct UPFs.

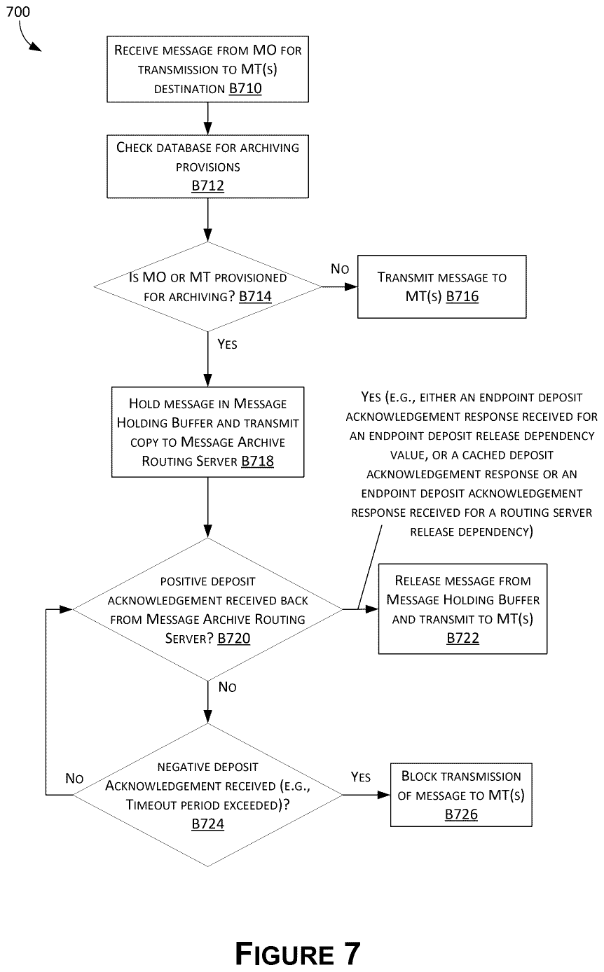

FIG. 7 is a flow chart illustrating a method 700 for archival message deposit confirmation as performed by an IMS core and/or message hold-and-release function, according to some embodiments. It should be understood that the features and elements described herein with respect to the method of FIG. 7 may be used in conjunction with, in combination with, or substituted for elements of any of the other embodiments discussed herein and vice versa. Further, it should be understood that the functions, structures, and other descriptions of elements for embodiments described in FIG. 7 may apply to like or similarly named or described elements across any of the figures and/or embodiments described herein and vice versa. In some embodiments, elements of method 700 are implemented utilizing one or more processing units comprising processing circuitry, such as the controller of an operator core network, a network node, a networked server, an edge server, an access network, a RAN, user equipment (UE), a computing device, a cloud computing environment, and/or other processing units or computing devices as disclosed in any of the embodiments herein. In some embodiments, the method 700 may be implemented by components of a telecommunications network environment 600, such as illustrated by FIG. 6.

The method 700, at B710, includes receiving (e.g., at IMS core 150) a message from an MO that has been provisioned for transmission to one or more MT(s). The method proceeds to B712 with checking a database (e.g., the message subscriber database 122) to determine what archiving provisions apply to the message. For example, the subscriber archiving profile(s) for the MO and/or MT(s) may be ready from the message subscriber database 122 to determine if the subscriber archiving profile(s) include a specification of an archive endpoint (indicating that archiving is provisioned), and if so a corresponding release dependency value (e.g., an endpoint deposit dependency value or a routing server dependency value). If archiving is not provisioned for the received message (checked at B714), then the method may proceed to B716 to transmit the message to the MT(s).

If archiving is provisioned for the received message (checked at B714), then the method may proceed to B718 with holding the message in a message holding buffer (e.g., message holding buffer 314), and transmitting a copy of the message to the message archive routing server (e.g., message archive routing server 120) for deposit to an archiving platform (internal or external). The message may remain in the message holding buffer and held from being further transmitted to the MT(s) pending a receipt of a positive archive archiving acknowledgement back from the message archive routing server (checked at B720). For a message where the release dependency value from the message subscriber database is an endpoint deposit dependency value, a positive archive archiving acknowledgement comprises an endpoint deposit acknowledgement response indicating that message archive routing server has received an acknowledgement from the archiving platform that the copy of the message has been successfully received for archiving by the archiving platform. For a message where the release dependency value from the message subscriber database is a routing server deposit dependency value, a positive archive archiving acknowledgement may comprise either: an endpoint deposit acknowledgement response indicating that the message archive routing server has received an acknowledgement from the archiving platform that the copy of the message has been successfully received for archiving by the archiving platform, or a cached deposit acknowledgement response indicating that the message archive routing server has successfully received the copy of the message and has queued the copy of the message for subsequent deposit to the archiving platform. When a positive archiving acknowledgement is received, the method proceeds to B722 where the message may be released from the message holding buffer and transmitted to the MT(s).

When a positive archiving acknowledgement has not been received, the method proceeds to B724 to determine if a negative deposit acknowledgement has been received. It should be understood that within the context of this disclosure, negative deposit acknowledgement may comprise a receipt of a negative acknowledgement message (e.g., a NACK) affirmatively indicating that some form of a message archive deposit failure has occurred, or receipt of a negative deposit acknowledgement may be considered to occur when the expected form of a positive archiving acknowledgement has not been received within a timeout period. As such, at B724 when the method determines that a negative deposit acknowledgement has occurred, then the method may proceed to B726 with blocking transmission of the message from the MO to the MT(s). The message may be purged from the message holding buffer. In some embodiments, if MO notifications are provisioned, a notification may be transmitted to the MO, indicating that the MO's message has not been transmitted.

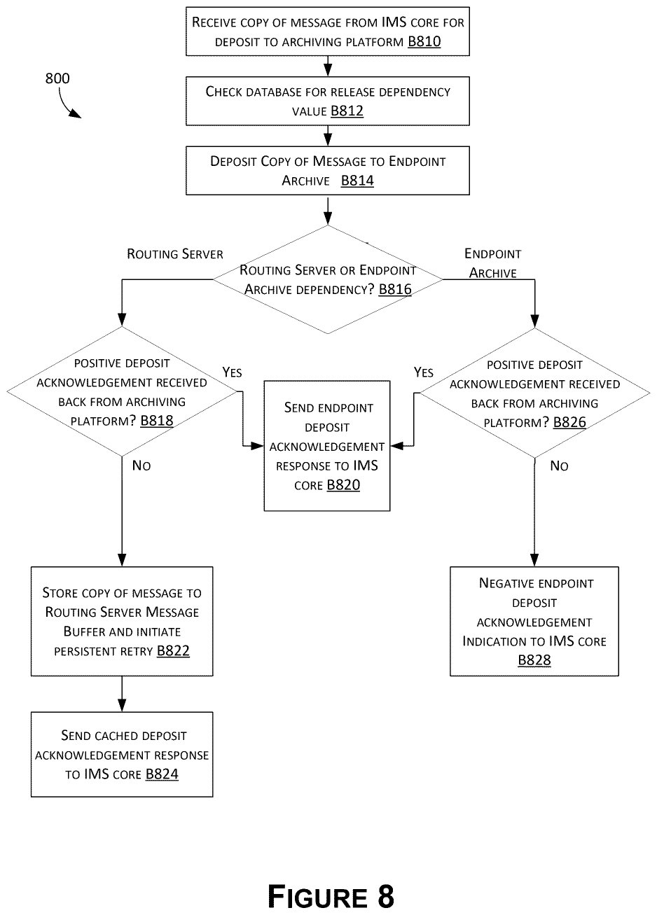

FIG. 8 is a flow chart illustrating an example method for archival message deposit confirmation as performed by a message archive routing server and/or adaptive deposit acknowledgement function, according to some embodiments. It should be understood that the features and elements described herein with respect to the method of FIG. 8 may be used in conjunction with, in combination with, or substituted for elements of any of the other embodiments discussed herein and vice versa. Further, it should be understood that the functions, structures, and other descriptions of elements for embodiments described in FIG. 8 may apply to like or similarly named or described elements across any of the figures and/or embodiments described herein and vice versa. In some embodiments, elements of method 800 are implemented utilizing one or more processing units comprising processing circuitry, such as the controller of an operator core network, a network node, a networked server, an edge server, an access network, a RAN, user equipment (UE), a computing device, a cloud computing environment, and/or other processing units or computing devices as disclosed in any of the embodiments herein. In some embodiments, the method 800 may be implemented by components of a telecommunications network environment 600, such as illustrated by FIG. 6.

The method 800, at B810, includes receiving (e.g., at message archive routing server 120 from the IMS core 150) a copy of a message from an MO that has been provisioned for transmission to one or more MT(s). The method proceeds to B812 with checking a database (e.g., the message subscriber database 122) to determine the archiving provisions that apply to the message. For example, the subscriber archiving profile(s) for the MO and/or MT(s) may be read from the message subscriber database 122 to determine the specification of one or more archive platforms for depositing the copy of the message, and a corresponding release dependency value (e.g., an endpoint deposit dependency value or a routing server dependency value). The method may then proceed to B814 where the copy of the message may be transmitted to the specified archive platform(s) for deposit. As discussed herein, the message archive routing server may adapt the type and/or contents of acknowledgement it provides back to the IMS core based on the release dependency value associated with the message.

For example, in the case where the release dependency value indicates a routing server dependency (shown at B816), the method may proceed to B818. Here, when a positive archiving acknowledgement is received back from the archiving platform (an endpoint deposit acknowledgement response indicating that the message archive routing server has received an acknowledgement from the archiving platform that the copy of the message has been successfully received for archiving by the archiving platform), the message archive routing server may proceed to B820 and transmit an endpoint deposit acknowledgement response to the IMS core. When a positive archiving acknowledgement is not received back from the archiving platform, the method may proceed to B822. At B822, a copy of the message may be stored to a routing server message buffer (e.g., routing server message buffer 320) and the persistent retry function initiated. As discussed herein, the adaptive deposit acknowledgement function 154 may cache the transmitted message data to the routing server message buffer 320 for a specified period (e.g., hours, days, or weeks) while executing a persistent retry function to repeatedly attempt to deposit the copy of the message to the archiving platform. The method may then proceed to B824 and send the cached deposit acknowledgement response to the IMS core.

In the case where the release dependency value indicates an archive endpoint dependency (checked at B816), the method may proceed to B826. Here, when a positive archiving acknowledgement is received back from the archiving platform (an endpoint deposit acknowledgement response indicating that the message archive routing server has received an acknowledgement from the archiving platform that the copy of the message has been successfully received for archiving by the archiving platform), the message archive routing server may proceed to B820 and transmit an endpoint deposit acknowledgement response to the IMS core. When a positive archiving acknowledgement is not received back from the archiving platform, the method may proceed to B828. At B828, the IMS core may be provided with a negative endpoint acknowledgement indication. As discussed, a negative deposit acknowledgement may comprise a receipt of a negative acknowledgement message (e.g., a NACK) affirmatively indicating that some form of a message archive deposit failure has occurred, or a negative deposit acknowledgement indication may be provided in the form of not sending a positive archiving acknowledgement within a timeout period.

FIG. 9 is a flow chart illustrating an example method for archival message deposit confirmation, according to some embodiments. It should be understood that the features and elements described herein with respect to the method of FIG. 9 may be used in conjunction with, in combination with, or substituted for elements of any of the other embodiments discussed herein and vice versa. Further, it should be understood that the functions, structures, and other descriptions of elements for embodiments described in FIG. 9 may apply to like or similarly named or described elements across any of the figures and/or embodiments described herein and vice versa. In some embodiments, elements of method 900 are implemented utilizing one or more processing units comprising processing circuitry, such as the controller of an operator core network, a network node, a networked server, an edge server, an access network, a RAN, user equipment (UE), a computing device, a cloud computing environment, and/or other processing units or computing devices as disclosed in any of the embodiments herein. In some embodiments, the method 900 may be implemented by components of a telecommunications network environment 600, such as illustrated by FIG. 6.

The method 900, at B910, includes storing message data to a message holding buffer, the message data representing encrypted message content received by a messaging system from a message originator (MO) for delivery by the messaging system to at least one message target (MT). In some embodiments, the messaging system may comprise an IP Multimedia Subsystem (IMS) core of a telecommunications network. As discussed herein with respect to FIG. 1, an operating environment 100 may comprise an IP Multimedia Core Network Subsystem (IMS) core 150 that operates as a standardized architectural framework for a messaging system that facilitates the delivery of messages between an MO and one or more MTs over a network (e.g., IP networks such as the Internet). The IMS core 150 may manage session control, authentication, and authorization, enabling users to access messaging services (e.g., Short Message Service (SMS), Multimedia Messaging Service (MMS), Rich Communication Services (RCS), Unstructured Supplementary Service Data (USSD) and/or other message exchange services) securely and efficiently. In the case where message archiving has been provisioned for this MO and/or MT, then the IMS core 150 activates the message hold-and-release function 152 to store a copy of the transmitted message data to the message holding buffer 314, pending receipt of a deposit acknowledgement 318 (e.g., a router server or endpoint acknowledgement) as specified by the corresponding subscriber archiving profile 124 as discussed with respect to FIG. 2.

The method 900, at B912, includes sending a message deposit request comprising a copy of the message data to a message archival routing server for deposit to an archiving platform. As shown in FIG. 3, with the message hold-and-release function 152 and the transmitted message data held within (stored to) the message holding buffer 314, the IMS core 150 may proceed to send a deposit request 316 to the message archive routing server 120, where the deposit request 316 carries the copy of transmitted message data 205 shown in FIG. 2. The message archive routing server 120 accesses the subscriber archiving profile 124 for one or more of the subscriber IDs associated with the deposit request 316 (e.g., subscriber ID(s) for the MO and/or MT(s)) and sends the copy of the transmitted message data as an endpoint deposit request 322 to the archiving platform 330 indicated by a partner ID from the subscriber archiving profile 124. The copy of the transmitted message data for deposit to an archiving platform may be deposited based on an encryption and authentication protocol based at least on one or more of: secure sockets layer (SSL), transport layer security (TLS), or mutual transport layer security (mTLS). In some embodiments, the archiving platform may be implemented by an edge server of a core network edge of a telecommunications network.

The method 900, at B914, includes evaluating an acknowledgement response from the message archival routing server to identify a positive deposit acknowledgement, wherein the positive deposit acknowledgement is defined based on a subscriber archiving profile associated with at least one of the MO or the at least one MT. For example, the message hold-and-release function 152 may query the message subscriber database 122 to obtain a subscriber archiving profile 124 to identify if one or more subscriber IDs associated with the message are provisioned for message archiving. In accordance with one or more embodiments of this disclosure, the adaptive deposit acknowledgement function 154 may control the message archive routing server 120 to output a deposit acknowledgement 318 to the IMS core 150. The contents of the deposit acknowledgement 318 may vary based on a deposit acknowledgement 324 provided by the archiving platform 330 and the release dependency value provided by the subscriber archiving profile 124. For example, in some embodiments, the archiving platform 330 may provide a positive deposit acknowledgement 324 back to the message archive routing server 120, which is processed by the adaptive deposit acknowledgement function 154. Such a positive deposit acknowledgement 324 may indicate that the endpoint deposit request 322 was successfully received and processed by the archiving platform 330 (e.g., a copy of the message was archived to the encrypted message archive 340). In that case, the adaptive deposit acknowledgement function 154 may generate a positive deposit acknowledgement 318 to the IMS core 150 that indicates a successful deposit of the message to the archiving platform 330.

The method 900, at B916, includes, in response to identification of the acknowledgement response as comprising the positive deposit acknowledgement, releasing the message data from the message holding buffer and transmitting the message data to the at least one MT. The method 900, at B918, includes, in response to identification of the acknowledgement response as not comprising the positive deposit acknowledgement, blocking transmission of the message data to the at least one MT.

For a message where the release dependency value from the message subscriber database is an endpoint deposit dependency value, a positive archive archiving acknowledgement comprises an endpoint deposit acknowledgement response indicating that the message archive routing server has received an acknowledgement from the archiving platform that the copy of the message has been successfully received for archiving by the archiving platform. For a message where the release dependency value from the message subscriber database is a routing server deposit dependency value, a positive archive archiving acknowledgement may comprise either: an endpoint deposit acknowledgement response indicating that the message archive routing server has received an acknowledgement from the archiving platform that the copy of the message has been successfully received for archiving by the archiving platform (that is, an indication that the copy of the message data was accepted for deposit by the archiving platform), or a cached deposit acknowledgement response indicating that the message archive routing server has successfully received the copy of the message and has queued the copy of the message for subsequent deposit to the archiving platform (e.g., that the copy of the message data has been queued for deposit to the archiving platform by the message archival routing server). As discussed herein, the adaptive deposit acknowledgement function 154 may cache the transmitted message data to the routing server message buffer 320 for a specified period (e.g., hours, days, or weeks) while executing a persistent retry function to repeatedly attempt to deposit the copy of the message to the archiving platform.

When a positive archiving acknowledgement is received, the message may be released from the message holding buffer and transmitted to the MT(s). When a positive archiving acknowledgement has not been received, the method may determine if a negative deposit acknowledgement has been received. A negative deposit acknowledgement may comprise a receipt of a negative acknowledgement message (e.g., a NACK) affirmatively indicating that some form of a message archive deposit failure has occurred, or receipt of a negative deposit acknowledgement may be considered to occur when the expected form of a positive archiving acknowledgement has not been received within a timeout period. The method may proceed to block transmission of the message from the MO to the MT(s) and in some embodiments, the message may be purged from the message holding buffer. In some embodiments, if MO notifications are provisioned, a notification may be transmitted to the MO indicating that the MO's message has not been transmitted.

Referring to FIG. 10, a diagram is depicted of an exemplary computing environment suitable for use in implementations of the present disclosure. In particular, the exemplary computer environment is shown and designated generally as computing device 1000. Computing device 1000 is but one example of a suitable computing environment and is not intended to suggest any limitation as to the scope of use or functionality of the embodiments described herein, and nor should computing device 1000 be interpreted as having any dependency or requirement relating to any one or combination of components illustrated. In various embodiments, one or more aspects of a message routing server 126, a message archive routing server 120, a message subscriber database 122, a message hold-and-release function 152, an adaptive deposit acknowledgement function 154, a primary message archiving platform 142, an internal archiving platform 130, and/or a computing device 136, as described herein, may be implemented at least in part using a computing device 1000.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 10, computing device 1000 includes bus 1010 that directly or indirectly couples the following devices: memory 1012, one or more processors 1014, one or more presentation components 1016, input/output (I/O) ports 1018, I/O components 1020, power supply 1022, and radio 1024. Bus 1010 represents what may be one or more buses (such as an address bus, data bus, or combination thereof). The devices of FIG. 10 are shown with lines for the sake of clarity. However, it should be understood that the functions performed by one or more components of the computing device 1000 may be combined or distributed amongst the various components. For example, a presentation component such as a display device may be one of I/O components 1020. In some embodiments, one or more functions of one or more aspects of a message routing server 126, a message archive routing server 120, a message subscriber database 122, a primary message archiving platform 42, an internal archiving platform 130, a message hold-and-release function 152, an adaptive deposit acknowledgement function 154, and/or a computing device 136, as described herein, may be executed at least in part by computing device 1000. The processors 1014 of computing device 1000 may include a memory. The present disclosure hereof recognizes that such is the nature of the art, and reiterates that FIG. 10 is merely illustrative of an exemplary computing environment that can be used in connection with one or more implementations of the present disclosure. Distinction is not made between such categories as “workstation,” “server,” “laptop,” “handheld device,” “smart television,” etc., as all are contemplated within the scope of FIG. 10 and refer to “computer” or “computing device.”

Computing device 1000 typically includes a variety of one or more computer-readable media storing computer-usable instructions. For example, applications, algorithms, and/or neural networks may be stored in a memory comprising such computer-readable media. Computer-readable media can be any available media that can be accessed by computing device 1000 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data.

Computer storage media includes non-transient random-access memory (RAM), read-only memory (ROM), electrically erasable programmable read-only memory (EEPROM), flash memory or other memory technology, compact disk (CD)-ROM, digital versatile disks (DVDs) or other optical disk storage, magnetic cassettes, magnetic tape, magnetic disk storage, or other magnetic storage devices. Computer storage media and computer-readable media do not comprise a propagated data signal or signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer-readable media.

Memory 1012 includes computer storage media in the form of volatile and/or non-volatile memory. Memory 1012 may be removable, non-removable, or a combination thereof. Exemplary memory includes solid-state memory, hard drives, optical-disc drives, etc. Computing device 1000 includes one or more processors 1014 that comprise processing circuitry and that read data from various entities such as bus 1010, memory 1012, and/or I/O components 1020. Processors 1014 may include one or more central processing units (CPUs) 1026, and/or one or more graphics processing units (GPUs) 1028, and/or other processing circuitry. In some embodiments, one or more functions of one or more aspects of a message routing server 126, a message archive routing server 120, a message subscriber database 122, primary message archiving platform(s) 142, an internal archiving platform 130, message hold-and-release function 152, adaptive deposit acknowledgement function 154, and/or a computing device 136, as described herein, may include software code executed on CPUs 1026 and/or GPUs 1028. One or more presentation components 1016 present data indications to a person or other device. Exemplary one or more presentation components 1016 include a display device, speaker, printing component, vibrating component, etc. I/O ports 1018 allow computing device 1000 to be logically coupled to other devices including I/O components 1020, some of which may be built into computing device 1000. Illustrative I/O components 1020 include a microphone, joystick, game pad, satellite dish, scanner, printer, wireless device, etc. In some embodiments, the I/O components 1020 may include a network interface card (NIC) for coupling to a network, such as is described herein.

Radio(s) 1024 represents a radio that facilitates communication with a wireless telecommunications network (such as telecommunications network 600). For example, radio(s) 1024 may be used to establish communications with components of an access network 602, operator core network 650, and/or core network edge 611. Illustrative wireless telecommunications technologies include code-division multiple access (CDMA), general packet radio service (GPRS), time-division multiple access (TDMA), global system for mobile communications (GSM), and the like. Radio(s) 1024 may additionally or alternatively facilitate other types of wireless communications including Wi-Fi, WiMAX, LTE, and/or other voice-over-internet protocol (VoIP) communications. In some embodiments, radio(s) 1024 may support multimodal connections that include a combination of 3GPP radio technologies (e.g., 4G, 5G, and/or 6G) and/or non-3GPP radio technologies. As can be appreciated, in various embodiments, radio(s) 1024 can be configured to support multiple technologies, and/or multiple radios can be utilized to support multiple technologies. In some embodiments, the radio(s) 1024 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

Referring to FIG. 11, a diagram is depicted generally at 1100 of an exemplary cloud computing environment 1110 for implementing one or more aspects of archival message deposit confirmation logic, as implemented by the systems and methods described herein. Cloud computing environment 1110 is but one example of a suitable cloud computing environment and is not intended to suggest any limitation as to the scope of use or functionality of the embodiments presented herein, and nor should cloud computing environment 1110 be interpreted as having any dependency or requirement relating to any one or combination of components illustrated. In some embodiments, the cloud computing environment 1110 is coupled to a network 1105 (e.g., network 105) and/or may be executed within operator core network 650, the core network edge 611, edge server 630, or otherwise coupled to the core network edge 611 or operator core network 650.

Cloud computing environment 1110 includes one or more controllers 1120 comprising one or more processors and memory. The controllers 1120 may comprise servers of a data center. In some embodiments, the controllers 1120 are programmed to execute code to implement at least one or more aspects of network operating environment 100 and/or telecommunications network environment 600 as described herein. For example, in one embodiment a network function for message hold-and-release function 152 and/or adaptive deposit acknowledgement function 154 as discussed herein may be implemented as one or more virtual network functions (VNFs) 1130 (which may include one or more container network functions (CNFs) running on a worker node cluster 1125 established by the controllers 1120.

The cluster of worker nodes 1125 may include one or more orchestrated Kubernetes (K8s) pods that realize one or more containerized applications 1135. In other embodiments, another orchestration system may be used. For example, the worker nodes 1125 may use lightweight Kubernetes (K3s) pods, Docker Swarm instances, and/or other orchestration tools. In some embodiments, one or more elements of the environment 100 may be implemented by, or coupled to, the controllers 1120 of the cloud computing environment 1110 by network 105, operator core network 650, and/or core network edge 611. In some embodiments, one or more elements of a message holding buffer 314, routing server message buffer 320, and/or message subscriber database 122 may be implemented at least in part using one or more data store persistent volumes 1140 in the cloud computing environment 1110.

In various alternative embodiments, system and/or device elements, method steps, or example implementations described throughout this disclosure (such as the UE, network nodes, servers, access networks, core network edge, operator core network, network functions, archive platforms, and/or any of the sub-parts thereof, for example) may be implemented at least in part using one or more computer systems, field-programmable gate arrays (FPGAs), application-specific integrated circuits (ASICs), or similar devices comprising a processor coupled to a memory and executing code to realize the elements and/or processes, with said code stored on a non-transient hardware data storage device. Therefore, other embodiments of the present disclosure may include elements comprising program instructions resident on computer-readable media that when implemented by such computer systems enable them to implement the embodiments described herein. As used herein, the term “computer-readable media” refers to tangible memory storage devices having non-transient physical forms. Such non-transient physical forms may include computer memory devices, such as but not limited to: punch cards, magnetic disk or tape, any optical data storage system, flash read-only memory (ROM), non-volatile ROM, programmable ROM (PROM), erasable-programmable ROM (E-PROM), random-access memory (RAM), or any other form of permanent, semi-permanent, or temporary memory storage system of a device having a physical, tangible form. Program instructions include, but are not limited to, computer-executable instructions executed by computer system processors and hardware description languages such as Verilog or Very High-Speed Integrated Circuit (VHSIC) Hardware Description Language (VHDL).

As used herein, the terms “network function,” “framework,” “processor,” “controller,” “unit,” “model,” “core,” “server,” “node,” “module,” and similar phrases are used to describe computer processing components (e.g., processing circuitry) and/or one or more computer-executable services being executed on one or more computer processing components. In the context of this disclosure, such terms used in this manner would be understood by one skilled in the art to refer to specific network and/or computing elements and are not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings, which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system comprising:
one or more processors; and
one or more computer-readable media storing computer-usable instructions that, when executed by the one or more processors, cause the one or more processors to:
store message data to a message holding buffer, the message data representing encrypted message content received by a messaging system from a message originator (MO) for delivery by the messaging system to at least one message target (MT);
send a message deposit request comprising a copy of the message data to a message archival routing server for deposit to an archiving platform;
evaluate an acknowledgement response from the message archival routing server to identify a positive deposit acknowledgement, wherein the positive deposit acknowledgement is defined based on a subscriber archiving profile associated with at least one of the MO or the at least one MT;
in response to identification of the acknowledgement response as comprising the positive deposit acknowledgement, release the message data from the message holding buffer and transmit the message data to the at least one MT; and
in response to identification of the acknowledgement response as not comprising the positive deposit acknowledgement, block transmission of the message data to the at least one MT.

2. The system of claim 1, wherein the one or more processors are further to identify the acknowledgement response as a positive deposit acknowledgement when the acknowledgement response includes an indication that the copy of the message data was accepted for deposit by the archiving platform.

3. The system of claim 1, wherein the one or more processors are further to identify the acknowledgement response as a positive deposit acknowledgement when the acknowledgement response includes an indication that the copy of the message data has been queued for deposit to the archiving platform by the message archival routing server.

4. The system of claim 3, wherein the message archival routing server executes a persistent retry function that repeatedly attempts to deposit the copy of the message data to the archiving platform.

5. The system of claim 1, wherein the one or more processors are further to identify the acknowledgement response as a negative acknowledgement based on not receiving the positive deposit acknowledgement within a timeout period, wherein the transmission of the message data to the at least one MT is blocked based on the negative acknowledgement.

6. The system of claim 1, wherein based on the subscriber archiving profile comprising a routing server dependency value, the message archival routing server generates:
an endpoint deposit acknowledgement response based on an indication from the archiving platform that the copy of the message data was successfully received; and
a cached deposit acknowledgement response when the message archival routing server saves the copy of the message data to a queue for deposit to the archiving platform in response to not receiving the indication from the archiving platform that the copy of the message data was successfully received; and
wherein the one or more processors identify both the endpoint deposit acknowledgement response and the cached deposit acknowledgement response as the positive deposit acknowledgement when the subscriber archiving profile comprises the routing server dependency value.

7. The system of claim 1, wherein based on the subscriber archiving profile comprising an archive endpoint dependency value, the message archival routing server generates:
an endpoint deposit acknowledgement response based on an indication from the archiving platform that the copy of the message data was successfully received; and
a negative deposit acknowledgement in response to not receiving the indication from the archiving platform that the copy of the message data was successfully received; and
wherein the one or more processors identify the endpoint deposit acknowledgement response as the positive deposit acknowledgement when the subscriber archiving profile comprises the archive endpoint dependency value.

8. The system of claim 1, wherein the one or more processors are further to:
transmit a notification to the MO in response to identification of the acknowledgement response as not comprising the positive deposit acknowledgement.

9. The system of claim 1, wherein the subscriber archiving profile is selected from a message subscriber database based at least on a subscriber identifier (ID) for at least one of the MO or the one or more MTs.

10. The system of claim 1, wherein the subscriber archiving profile includes an archive endpoint value representing an identity of the archiving platform.

11. A telecommunications network, the network comprising:
an operator core network comprising an IP Multimedia Subsystem (IMS) core that includes a message hold-and-release function;
a message archive routing server coupled to the operator core network; and
one or more access networks coupled to the operator core network, wherein the IMS core receives message data representing encrypted message content via the one or more access networks from at least a message originator (MO) user equipment (UE) and for delivery to at least one message target (MT) UE; and
wherein the IMS core executes one or more operations to:
buffer the message data to a message holding buffer;
send a message deposit request comprising a copy of the message data to the message archival routing server for deposit to an archiving platform; and
hold the message data in the message holding buffer without forwarding the message data to the at least one MT pending receipt of an acknowledgement response from the message archive routing server that comprises a positive deposit acknowledgement; and
wherein the message archive routing server executes operations to:
determine a release dependency value associated with the copy of the message data based on a subscriber archiving profile associated with the message data;
send an endpoint deposit request to the archiving platform, the endpoint deposit request comprising a copy of the message data; and
determine the acknowledgement response based at least on a response of the archiving platform to the endpoint deposit request and the release dependency value.

12. The network of claim 11, wherein the message archive routing server outputs the positive deposit acknowledgement when the response of the archiving platform to the endpoint deposit request includes an indication that the copy of the message data was accepted for deposit by the archiving platform.

13. The network of claim 11, wherein based on the subscriber archiving profile comprising a routing server dependency value, the message archival routing server generates:
an endpoint deposit acknowledgement response based on an indication from the archiving platform that the copy of the message data was successfully received; and
a cached deposit acknowledgement response when the message archival routing server saves the copy of the message data to a queue for deposit to the archiving platform in response to not receiving the indication from the archiving platform that the copy of the message data was successfully received; and
wherein the IMS core identifies both the endpoint deposit acknowledgement response and the cached deposit acknowledgement response as the positive deposit acknowledgement when the subscriber archiving profile comprises the routing server dependency value.

14. The network of claim 11, wherein based on the subscriber archiving profile comprising an archive endpoint dependency value, the message archival routing server generates:
an endpoint deposit acknowledgement response based on an indication from the archiving platform that the copy of the message data was successfully received; and
a negative deposit acknowledgement in response to not receiving the indication from the archiving platform that the copy of the message data was successfully received; and
wherein the IMS core identifies the endpoint deposit acknowledgement response as the positive deposit acknowledgement when the subscriber archiving profile comprises the archive endpoint dependency value.

15. The network of claim 11, wherein the IMS core transmits a notification to the MO in response to identification of the acknowledgement response as not comprising the positive deposit acknowledgement.

16. The network of claim 11, wherein the subscriber archiving profile is selected from a message subscriber database based at least on a subscriber identifier (ID) for at least one of the MO or the one or more MTs.

17. A method comprising:
buffering message data to a message holding buffer, the message data representing encrypted message content received by a messaging system from a message originator (MO) for delivery by the messaging system to at least one message target (MT);
sending a message deposit request comprising a copy of the message data to a message archival routing server for deposit to an archiving platform;
receiving an acknowledgement response from the message archival routing server in response to the message deposit request; and
when the acknowledgement response comprises a positive deposit acknowledgement, releasing the message data from the message holding buffer and transmitting the message data to the at least one MT, wherein the positive deposit acknowledgement indicates at least one of: that the copy of the message data was accepted for deposit by the archiving platform, or that the copy of the message data has been queued for deposit to the archiving platform by the message archival routing server.

18. The method of claim 17, the method further comprising:
determining a release dependency value associated with the copy of the message data based on a subscriber archiving profile associated with the message data; and
based on the subscriber archiving profile comprising a routing server dependency value, saving a copy of the message data to a queue for deposit to the archiving platform in response to not receiving an indication from the archiving platform that the copy of the message data was successfully received and executing a persistent retry function that repeatedly attempts to deposit the copy of the message data to the archiving platform.

19. The method of claim 17, the method further comprising:
determining a release dependency value associated with the copy of the message data based on a subscriber archiving profile associated with the message data;
based on the subscriber archiving profile comprising an archive endpoint dependency value, generating the acknowledgement response as a negative deposit acknowledgement in response to not receiving an indication from the archiving platform that the copy of the message data was successfully received; and
blocking transmission of the message data to the at least one MT based at least on the negative deposit acknowledgement.

20. The method of claim 17, the method further comprising:
transmitting a notification to the MO in response to determining that the positive deposit acknowledgement is not received within a timeout period.
